(19) United States
(12) Patent Application Publication
(10) Pub. No.: US 2026/0099650 A1
(43) Pub. Date: Apr. 9, 2026

(54) ELECTRONIC DESIGN AUTOMATION MACHINE LEARNING GRAPH REPRESENTATION LEARNING FRAMEWORK FOR DIGITAL IC DESIGN AUTOMATION

(71) Applicant: Drexel University, Philadelphia, PA (US)

(72) Inventors: Ioannis Savidis, Wallingford, PA (US); Pratik Shrestha, Philadelphia, PA (US); Alec Aversa, Philadelphia, PA (US); Saran Phatharodom, Philadelphia, PA (US)

(73) Assignee: Drexel University, Philadelphia, PA (US)

(21) Appl. No.: 19/299,188

(22) Filed: Aug. 13, 2025

Related U.S. Application Data
(60) Provisional application No. 63/683,104, filed on Aug. 14, 2024.

(51) Int. Cl. G06F 30/27; G06F 30/327; G06F 30/347

(52) U.S. Cl. CPC G06F 30/27; G06F 30/327; G06F 30/347

(57) ABSTRACT

A framework and associated data schema is used for machine learning-based prediction of performance metrics in digital integrated circuit (IC) design. In one aspect, a computer-implemented method converts design data from an initial design stage into one or more graph representations comprising nodes and edges, each annotated with structural, spatial, and performance-related features. A graph neural network, selected from a graph convolutional neural network (GCN), a spatial graph convolutional neural network (SGCN), or a hybrid thereof, processes the graph to generate embeddings for predicting one or more downstream performance metrics, including arrival time, interconnect parasitic impedance, total power, total area, or slack violations. Graph types include netlist, timing path, interconnect, clock network, and fused multi-graph representations. The method supports multi-stage and iterative predictions, feature importance analysis, ensemble models, and composite loss functions.

### BACKGROUND

This disclosure includes 2 subsections grouped under I and II within each section. Each section includes figures, tables, and equations that are preceded by a corresponding section number. For example, the Figures related to Section I all begin with 1.

### I. Background for Electronic Design Automation Machine Learning Graph Representation Learning Framework for Digital IC Design Automation

Electronic design automation (EDA) plays a crucial role in the design and development of modern integrated circuits (ICs), enabling engineers to produce complex and high-performing electronic systems. With the continuous scaling of CMOS technology, the design complexity of ICs has increased exponentially, posing significant challenges for traditional EDA methodologies. To address such challenges, researchers have turned to machine learning (ML) techniques, leveraging the ability to extract meaningful patterns and make informed predictions from large-scale datasets. The success of ML algorithms in EDA, however, relies on the quality of the data representations, as different representations either potentially reveal or obscure the underlying factors that produce variation within the data. In recent years, representation learning using graph neural networks (GNN) has emerged as a powerful framework for the application of ML algorithms, with the objective of learning effective representations directly from the data. Due to the ability to accurately capture intricate relationships and interactions between entities, graphs serve as effective representations of circuits that closely depict the hierarchical structure and interconnections among active and passive electronic components.

A considerable amount of time in modern electronic design automation is dedicated to the iterative execution of the design flow, with the objective of meeting circuit specifications based on different performance metrics. By accurately estimating performance metrics at various stages of the physical design flow, proactive adjustments to the circuit are possible, resulting in significant reductions in design time and effort. The challenges of downstream prediction are more efficiently addressed through a generalized framework for tasks that share a common problem formulation. The same sets of relevant features are, therefore, applicable across multiple design problems.

### A) Digital IC Design Flow

Electronic design automation (EDA) is a comprehensive, multi-stage process that facilitates the efficient and accurate design of an integrated circuit. The overall EDA design flow, as illustrated in FIG. 1, is divided into five stages: logical synthesis, floor planning, placement, clock network synthesis, and routing. The stages collectively enable the design and implementation of robust and high-performing digital circuits, while optimizing for power, performance, and area. Each stage of the IC design flow takes as input budgets and requirements defined as design constraints, as well as the output generated by the previous design stage. For example, during physical design, the placed circuit serves as a starting point for clock tree synthesis (CTS). Constraints are specific to the given design stage, further impacting the design process. Throughout the EDA flow, various data formats can be used to capture and represent different aspects of a circuit's design. The files generated at the end of each design stage are typically in a standardized format. The completion of each stage results in the generation of the following files:
1) Logical Netlist: Technology-specific verilog or VHDL files that use standard cells defined in the Process Design Kit (PDK) of a given technology node and are logical representations of the circuit.
2) Physical Netlist: Library Exchange Format (LEF) and Design Exchange Format (DEF) files that are technology-specific netlist representations with spatial information of input/output pins, standard cell placements, and interconnect routing.
3) Timing reports: Reports that are generated using a Static Timing Analysis (STA) tool and include information on timing paths, arrival time, and required time. Multiple timing paths are extracted from a single circuit.
4) Interconnect Parasitics: Standard Parasitic Extraction Format (SPEF) files [4] containing parasitic impedance information, specifically the resistance, inductance, and capacitance of a circuit. Interconnects are segmented into sections with reported RLC values, enabling accurate analysis and estimates of signal timing and power consumption. While estimated parasitics are obtained post-placement, the true parasitic impedance is determined after the completion of the routing process.

### B) Graph Representation Learning

Graph convolutional network (GCN) layers transform graphs into low-dimensional vector embeddings by leveraging message passing and graph convolution operations to capture and combine information from neighboring nodes. The embeddings encode structural and relational information, facilitating tasks that include node classification, regression, and graph clustering. A graph convolution layer is defined by an aggregation function and a multi-layer perceptron and operates on a directed graph G=(V, E), where v∈V represents a node and e∈E represents an edge in the graph.

The aggregation function is defined according to Equation (1) (FIG. 34), where Ei is the set of edges connecting node vi to all neighboring nodes represented by a set Vj such that node vj∈Vj, hj denotes node features applied as input to a convolutional layer, and uij is a trainable weight for aggregation of node vi for features of node vj. The representation of (1) in matrix form is given by H⁻=UHT, where H denotes the matrix of node features such that H⁻=[h⁻1, . . . , h⁻n], and U denotes a trainable weight matrix.

Spatial graphs represent data with nodes and edges that include spatial properties, which enable analysis and modeling of relationships within a physical or spatial context. Spatial graph convolution networks (SGCN) enhance traditional GCNs by incorporating node positions within the convolution operation, which enables models that use spatial features and learn from graphs that possess inherent spatial arrangements. SGCN extends the aggregation function as given by Equation (2) (FIG. 34), where pi and pj are the matrix representations of the coordinate location of nodes vi and vj, respectively, b is a bias vector, ReLU is a rectified linear activation function, and ⊙ represents element-wise multiplication. The extended aggregation function is used by the multi-layer perceptron layer, which provides an output given by Equation (3) (FIG. 34), where W is the trainable weight matrix.

### II. Background for EDA-Schema: A Graph Data Model Schema and Open Dataset for Digital Design Automation

With the continuous scaling of CMOS technology, the design complexity of integrated circuits (IC) has significantly increased, posing challenges for traditional design methodologies. To address such challenges, researchers have turned to machine learning (ML) techniques, leveraging the ability of ML algorithms to extract meaningful patterns and make informed predictions from large-scale datasets. The absence of easily accessible and curated circuit datasets as well as a universally accepted schema for organizing and sharing such datasets, however, has resulted in a range of challenges. The variation in technology nodes and design tools, the lack of open tools and nodes, the time-consuming scripting and parsing of design reports, the arbitrary pre-processing methods, the lack of meaningful benchmark comparisons, and, as previously mentioned, the absence of a standardized dataset limit the unified methodologies needed to formulate and evaluate machine learning problems.

While OpenABC-D is a dataset curated by synthesizing hardware IP with the open-source EDA tool Yosys-abc, the primary focus of the tool is logic synthesis optimization. Similarly, in METRICS2.1, standards and metrics for RTL-to-GDS design tools and flows are proposed. However, the tool only tracks a limited number of data points and does not consider the netlist and corresponding substructures, only capturing a subset of design metrics and ignoring many others considered for the ML driven design automation.

### SUMMARY OF THE EMBODIMENTS

### I. Summary for Electronic Design Automation Machine Learning Graph Representation Learning Framework for Digital IC Design Automation

The present disclosure relates to systems and methods for predicting performance metrics of digital integrated circuits using graph-based machine learning techniques and for generating parameterized datasets of integrated circuit designs in a standardized graph-based schema.

In one aspect, a computer-implemented method predicts one or more downstream performance metrics in an integrated circuit design flow by: (1) converting design data from an initial design stage into one or more graph representations comprising nodes and edges; (2) associating each node and edge with structural, spatial, and performance-related features; (3) applying a graph neural network selected from a graph convolutional neural network (GCN), a spatial graph convolutional neural network (SGCN), or a hybrid thereof to generate node-level and/or graph-level embeddings; and (4) predicting the one or more downstream performance metrics for a subsequent design stage using a machine learning model.

The prediction framework supports multi-stage predictions between any two or more points in the design flow and applies to a variety of metrics including arrival time, interconnect parasitic impedance, total power, total area, and slack violation counts. The graphs may include netlist graphs, timing path graphs, interconnect graphs, clock network graphs, or fused multi-graph representations. Feature importance analysis, including sensitivity analysis, SHAP values, or mutual information ranking, may be performed to optimize feature selection.

In another aspect, a graph-based data schema represents digital integrated circuits across multiple design stages. The schema includes graph entities such as netlist graphs, timing path graphs, interconnect graphs, and clock network graphs, each annotated with attributes from structural features, quality-of-results (QoR) metrics, and parasitic data. Tabular entities store features of subcomponents linked to corresponding graph entities. The schema supports interoperability with machine learning pipelines through standardized metadata formats such as JSON-LD, Croissant and ontology-based feature definitions.

A further aspect includes a method for generating a parameterized dataset of integrated circuit physical designs. The method synthesizes benchmark circuits into gate-level netlists, performs physical implementation under varied design parameters, extracts structural and performance metrics, and formats the results into the graph-based schema. The dataset may span multiple technology nodes, such as Skywater 130 nm, ASAP 7 nm, GF 12 nm, TSMC 28 nm, and NanGate 45 nm, and may be annotated with ontology metadata for feature standardization.

This disclosure introduces a task-agnostic graph representation learning framework for integrated circuit (IC) design automation, which effectively addresses the challenges presented by diverse data representations and metrics generated during the standard design flow. The framework converts circuit designs and performance metrics extracted from the EDA tools at different design stages into standardized graph representations, capturing structural relationships among design elements and encoding essential characteristics through graph convolutions for meaningful vectorized embeddings. The vectorized embeddings are used within a machine-learning flow to predict downstream metrics of an EDA design tool. The effectiveness of the framework is demonstrated by implementing and analyzing two distinct prediction tasks; specifically post-floorplan to post-routing arrival time prediction and post-placement to post-routing interconnect parasitic impedance prediction.

The framework employs a design flow that predicts downstream metrics by representing the circuit in an early design phase X and predicting metric M in a subsequent design phase Y. A task agnostic graph structure and a feature set based on benchmark circuits are proposed as components of the framework. This disclosure includes at least the following features:
A standardized set of graph structures and feature sets representing a digital circuit and corresponding circuit subcomponents,
A generalized ML flow to predict downstream performance metrics given the graph representation of the circuit in the current design phase, and
post-floorplan to postrouting arrival time prediction and post-placement to post-routing interconnect parasitic impedance prediction are evaluated to demonstrate the effectiveness of the framework in solving two separate prediction problems.

### II. Summary for EDA-Schema: A Graph Datamodel Schema and Open Dataset for Digital Design Automation

The disclosure also introduces an EDA-schema, an open and comprehensive graph schema, to address such challenges by providing a structured framework for representing datasets for digital design automation. The schema represents the physical attributes and quality-of-results (QoR) metrics of a circuit across various stages of the physical design flow, including logical synthesis, floor planning, placement, clock network synthesis, and global and local routing. Using the Skywater 130 nm process design kit (PDK) and the OpenROAD toolset, a dataset of physical designs is generated and analyzed based on the circuits from the IWLS'05 benchmark suite.

This disclosure presents a property graph schema developed to represent digital circuit data and the associated attributes. This further disclosure includes at least the following features:
A standardized set of graph structures and feature sets representing a digital circuit and corresponding subcomponents,
A dataset of physical designs generated from the IWLS'05 benchmark circuit suite using the open-source 130 nm Process Design Kit (PDK) provided by Skywater and the open-source toolset OpenROAD, and
An analysis of the dataset of physical designs, demonstrating the completeness, reproducibility, diversity, and extensibility provided by the dataset and schema for machine learning based EDA applications.

The formatted dataset of physical designs and the source code of the data model schema are released on GitHub1.

### BRIEF DESCRIPTION OF THE DRAWINGS

FIG. 1 shows an overall EDA design flow.

FIG. 2a shows a sample benchmark representation of a netlist graph NG and FIG. 2b shows a sample benchmark representation of a subset of timing path graphs TPG.

FIG. 3a shows a geometrical representation of the predicted routing path extracted from the post placement SPEF file and FIG. 3b shows a geometrical representation of the interconnect spatial graph based on the extracted routing path.

FIG. 4 shows a generalized template of the network architecture. The graph pooling layer and graph features are represented with dotted lines and are only used for graph level predictions.

FIGS. 5A and 5B show block representations of overall framework including training and test flow.

FIG. 6a shows the architecture of the learning network for arrival time prediction and FIG. 6b shows the architecture of the learning network for interconnect parasitic impedance prediction.

FIG. 7 shows a block representation of the physical design automation flow.

FIG. 8 shows an EDA-schema entity relationship diagram. Graph entities are highlighted in yellow, while the remaining are tabular entities.

FIG. 9a shows a sample benchmark circuit represented as a schematic diagram and FIG. 9b shows a sample benchmark circuit represented as a netlist graph NG.

FIG. 10 shows a clock network graph CNG extracted from the netlist graph NG.

FIG. 11a shows a geometrical representation of the estimated route based on data from the SPEF file and FIG. 11b shows a geometrical representation of the interconnect spatial graph based on the estimated routing provided after placement.

FIG. 12 shows timing path graphs T PG extracted from the netlist graph NG of the circuit shown in FIG. 9a.

FIG. 13a shows distribution of post-routing total area, total power, and worst case arrival time of all circuits across the dataset and FIG. 13b shows distribution of post-routing total area, total power, and worst case arrival time of all circuits across the dataset excluding the fpu, ethernet, des3_perf, and vga_lcd.

FIG. 14 shows the average logical depth of the timing paths of the combinational logic of each circuit in the dataset.

FIG. 15a shows distribution of the post-routing total area, total power, and worst case arrival time of the complete dataset and FIG. 15b shows distribution of the post-routing total area, total power, and worst case arrival time of the complete dataset with the exclusion of the fpu, ethernet, des3_perf, and vga_lcd circuits.

FIG. 16 shows an analysis of circuits meeting and violating the timing slack requirement.

FIG. 17 shows a distribution of post-routing quality of results metrics for total area, total power consumption, and worst case arrival time when considering design parameters of clock period, core aspect ratio, and core utilization.

FIG. 18 shows a distribution of post-routing Pearson's coefficient between the quality of results metrics for total area, total power, and worst case arrival time and the design parameters of clock period, core aspect ratio, and core utilization.

FIG. 19 shows Table 1 that shows node features of the netlist and timing path graphs.

FIG. 20 shows Table 2 that shows node features of the interconnect graph.

FIG. 21 shows Table 3 that shows graph features of the interconnect graph.

FIG. 22 shows Table 4 that shows benchmark circuits used to characterize the proposed ML framework.

FIG. 23 shows Table 5 that shows problem formulation and model analysis details for each case study.

FIG. 24 shows Table 6 that shows analysis of the mean absolute percentage error (MAPE) and mean absolute error (MAE) of the post-logical synthesis to post-routing arrival time prediction.

FIG. 25 shows Table 7 that shows analysis of the mean absolute percentage error (MAPE) and mean absolute error (MAE) of the post-placement to post-routing interconnect capacitance prediction.

FIG. 26 shows Table 8 that shows selected features from sensitivity analysis of the mean absolute percentage error (MAPE) of the post-logical synthesis to post-routing arrival time prediction and post-placement to post-routing interconnect capacitance prediction. Features providing negative contribution to the model are highlighted in red.

FIGS. 27a and 27b show halves of Table 9 that shows node features of the netlist and timing path graphs.

FIG. 28 shows Table 10 that shows a summary of circuit characteristics, computational time, and memory usage of the generated dataset of IWLS'05 benchmark circuits. Large circuits with median gate count greater than 50,000 are highlighted in red.

FIG. 29 shows Table 11 that shows constraints and parameters used to generate the dataset.

FIG. 30 shows Table 12 that shows analysis of timing paths that meet and violate the slack requirements of the circuit.

FIG. 31 shows Table 13 that shows circuits that exhibit no change in quality of results metrics with changes in a design parameter.

FIG. 32 shows Table 14 that shows features used for machine learning driven circuit prediction problems in prior work.

FIG. 33 shows Table 15 that shows averaged quality of results metrics evaluated across all design phases. Baseline errors estimating post-routing performance using post-floorplan, post-placement, and post-CTS metrics are also listed.

FIG. 34 shows Equations 1-5.

FIG. 35 shows Equations 6-8.

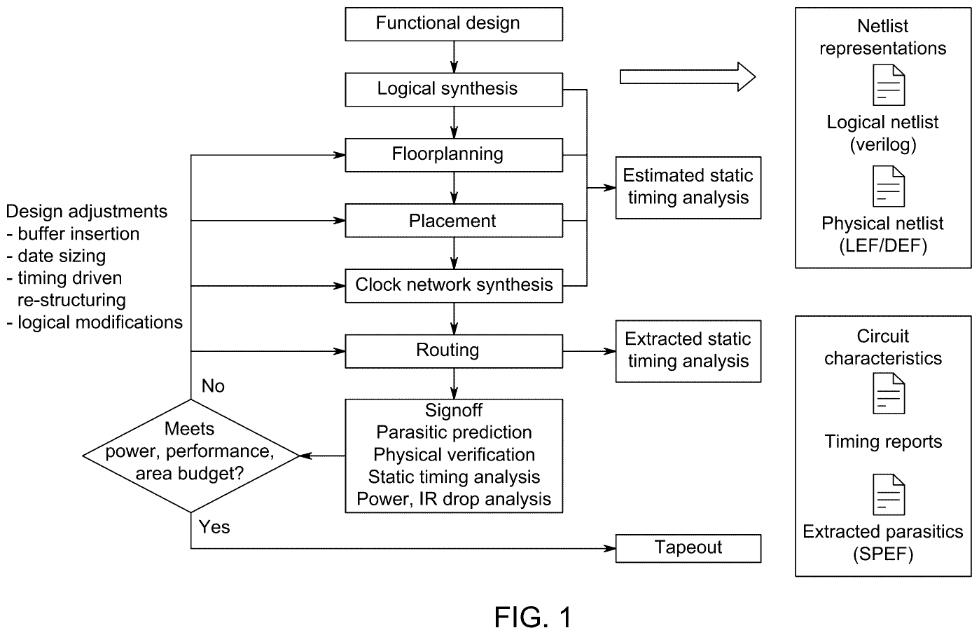

### DETAILED DESCRIPTION OF THE EMBODIMENTS

### I. Detailed Description for Electronic Design Automation Machine Learning Graph Representation Learning Framework for Digital IC Design Automation

### Graph Learning Framework

The objective of developing the graph learning framework is to efficiently and effectively address multiple classes of EDA tasks with techniques that leverage graph representation learning.

### A) Graph Structure and Feature Engineering

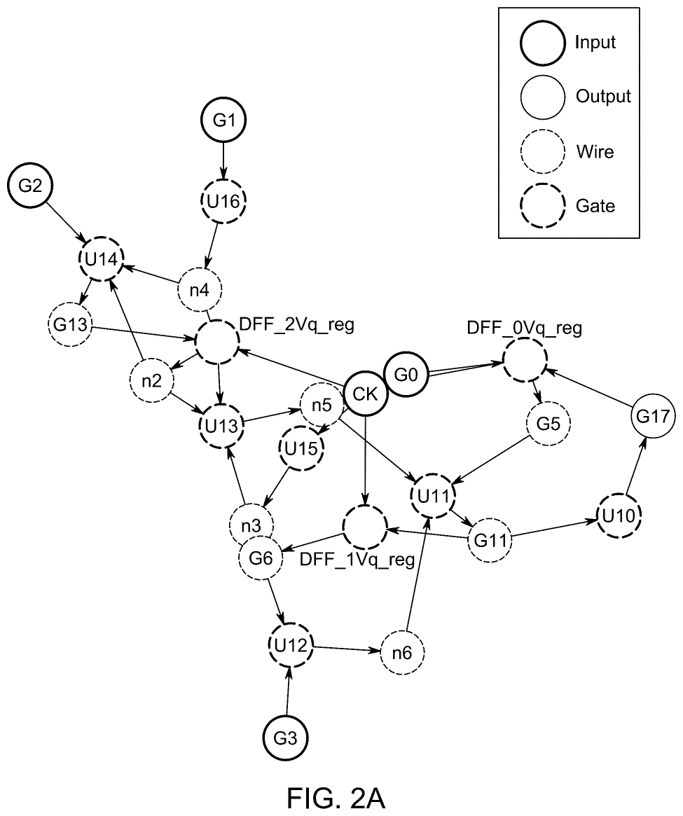

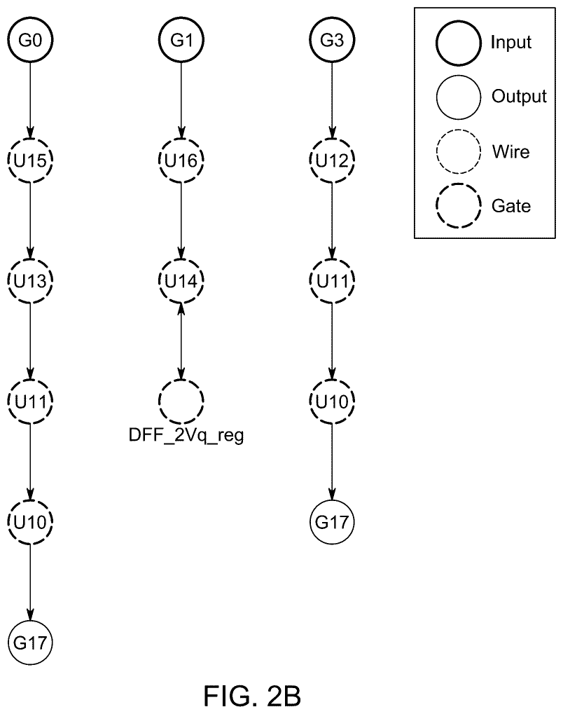

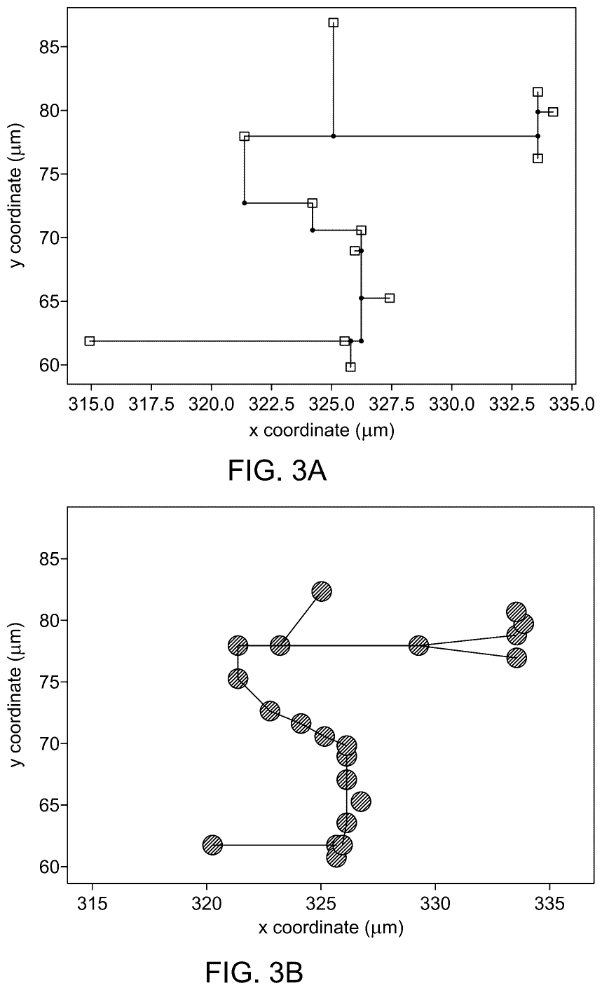

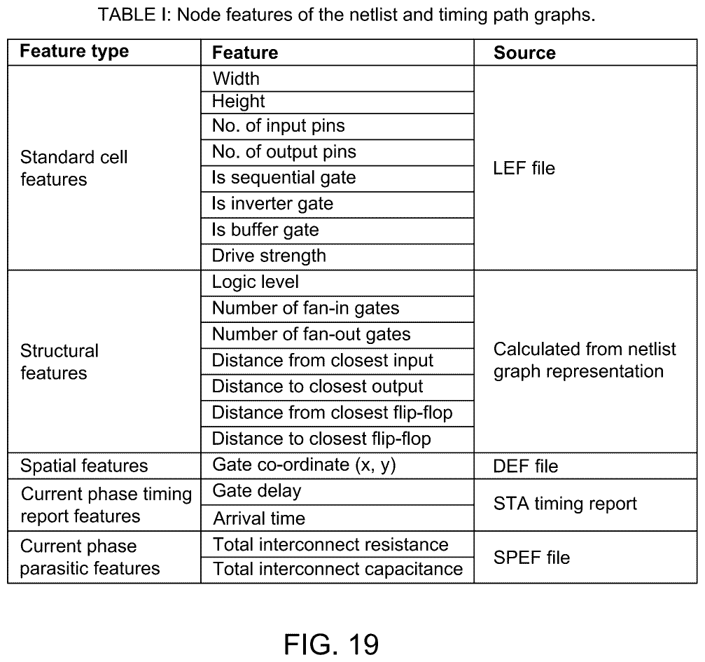

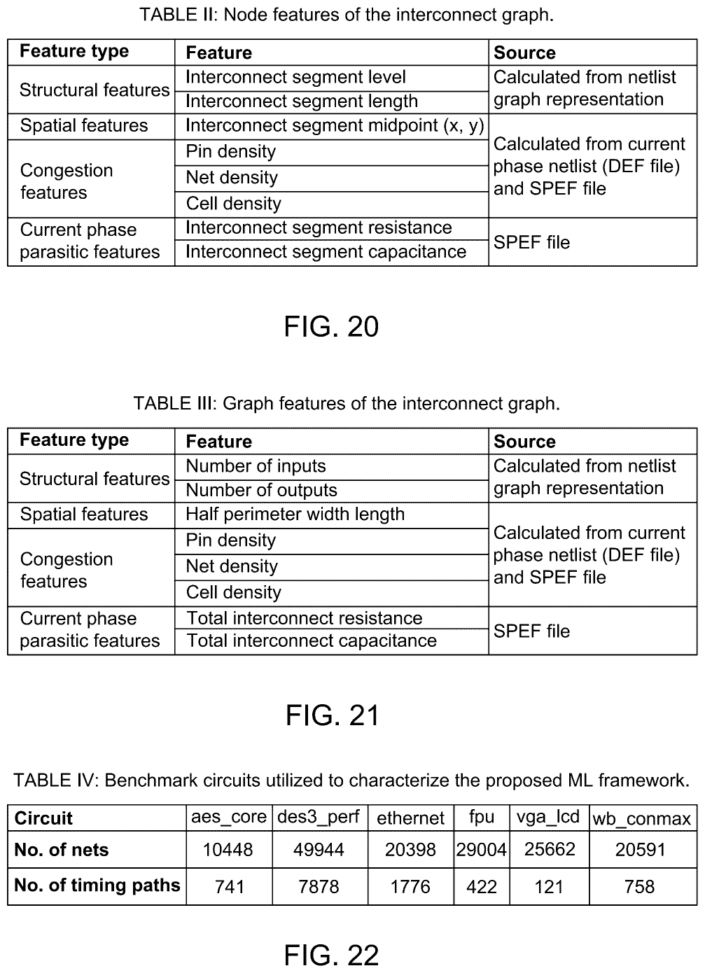

Circuits are represented as graphs, where nodes represent electronic components (e.g., cells, interconnects/wires, inputs, and output), and edges represent the connections between components. The graph is either directed or undirected, depending on the target problem and application. Each node and edge in the graph is associated with relevant features that capture essential information of the electronic components and the corresponding connections of each component.
Netlist Graph Representation: Circuit information is extracted from the Verilog and DEF files that includes the logical functionality of the gates, the input/output pin locations, the placement position/coordinates of the gates, and the interconnect routing paths. After parsing, the information is structured as a netlist graph denoted by NG=(V, E), where nodes v∈V correspond to inputs, outputs, and gates of a netlist, while edges e∈E represent the connections between two node components. A netlist graph for a simple circuit is depicted in FIG. 2a.
Timing Path Graphs: Static Timing Analysis (STA) is an important step of the physical design flow that ensures timing constraints are met by first identifying and then computing the arrival time and required time of critical signal paths (timing paths). Analysis of the timing paths optimizes the speed and reliability of the circuit. Subgraphs representing timing paths, denoted as timing path graphs TPG=(V, E), are derived from the netlist graph NG, with an example TPG shown in FIG. 2b. Each node of a timing path subgraph is populated with a carefully selected feature set, which is listed in Table 1, shown in FIG. 19. Detailed information on each standard cell is extracted from a technology-specific LEF file. Structural features are computed from the netlist graphs, while timing features are extracted from the STA timing reports generated by the EDA tools and mapped to the netlist of the circuit. In addition, parasitic impedance features, represented as net capacitances and resistances, are extracted from the SPEF files generated by IC Compiler.
Interconnect Graph: By extracting detailed information from the predicted placement of interconnect segments and the corresponding spatial relationships from the netlist graph, an interconnect graph is constructed, which enables a more comprehensive analysis of the physical characteristics of the circuit interconnects. An estimate of the physical characteristics (i.e. path) of the circuit interconnects is extracted from the SPEF file generated after placement, with an example of an interconnect path shown in FIG. 3a. The spatial information is parsed and mapped onto an interconnect graph IG =(V, E), where nodes v∈V represent estimated interconnect segments and edges e∈E represent connections between two or more interconnect segments. The interconnect graph captures the spatial layout and connections of the circuit. An example of an interconnect graph is shown in FIG. 3b. Each node of an interconnect graph is populated with the feature set listed in Table 2, shown in FIG. 20. The congestion features of each node of the interconnect graph are computed using the data on each interconnect segment obtained from the SPEF file. The circuit is divided into a grid of cells, each with dimensions of 10×10 μm², and the pin and node densities are calculated for each cell. The congestion feature for the graph node representing an interconnect segment is determined by the number of pins, nets, and cells per unit area in the grid region through which the interconnect segment passes. The entire interconnect graph is assigned the graph-level feature attributes listed in Table 3, FIG. 21.

### B) Generalized ML Flow

The proposed graph learning framework follows a generalized ML flow, which allows for the investigation of various downstream prediction tasks. The flow includes several key steps described as follows.

1) Problem Formulation: The definition of the problem (P) includes identifying the following:
The metric (M) to be predicted.
The initial phase (X) (e.g., post-floorplan, postplacement) and final phase (Y) (e.g., post-routing) of the design flow between which the prediction is made.
An appropriate graph representation (G), as described herein.
Whether the prediction is performed at the graph level (predicting a single value for the entire circuit) or node level (predicting values for individual components of the circuit).
A baseline metric (Mb) that serves as a reference for the evaluation of the effectiveness and improvement provided by the model.

2) Network Architecture: For problem P and the selected graph representation G, a general deep neural network model includes graph convolutional layers to encode the graph representation, followed by linear layers. The output of the neural network for the objective metric M is to be modeled. To improve the learning performed by the neural network, additional inputs, including the baseline reports from the initial design stage and numeric features, are provided to the first linear layer.

For node-level predictions, no additional pooling layer is required. However, for graph-level predictions, a pooling layer is added between the GCN layers and linear layers. The pooling layer aggregates the node-level features obtained through convolution, which results in graph-level features that represent the entire circuit.

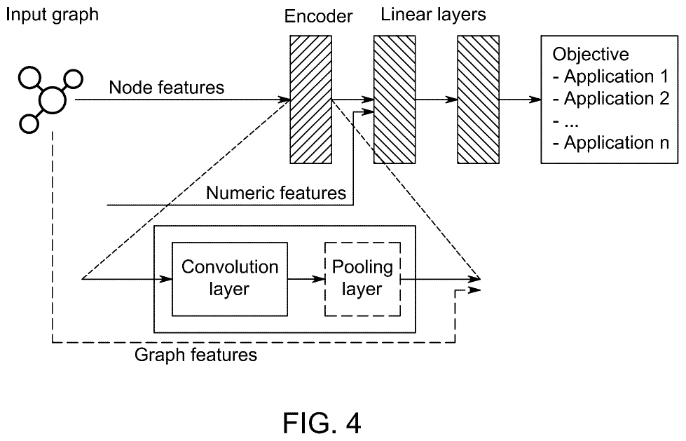

Graph-level attribute features are also included as inputs to the linear layers in addition to the numeric features. The inclusion of graph-level attributes provides valuable information on the overall characteristics of the circuit, augmenting the learning process and improving the predictive capabilities of the model. The overall structure of the network architecture is depicted in FIG. 4.

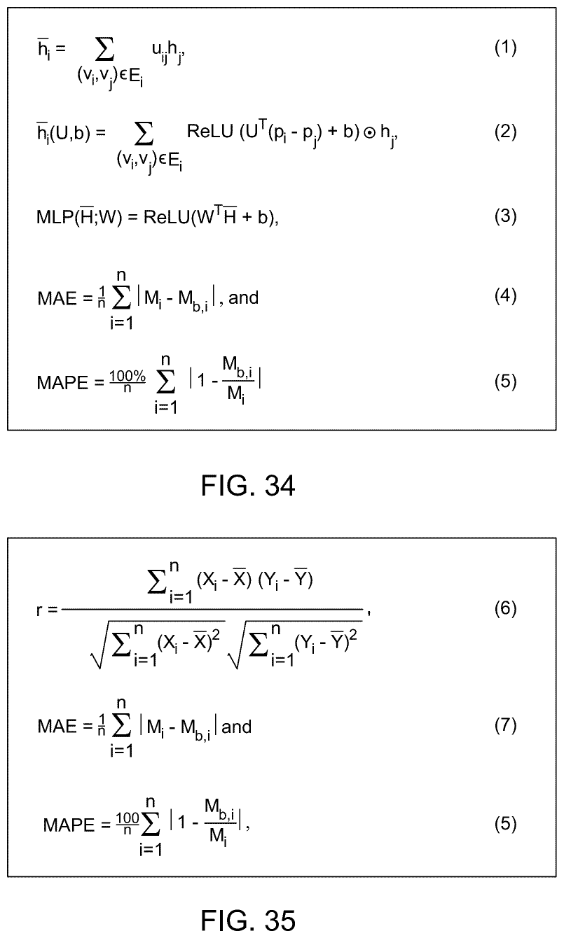

3) Training and Evaluation: In the training and evaluation phase of the generalized ML flow, the downstream metric prediction problem P is solved using a deep neural network for regression (DNNR). Primary options for DNNR include the selection of the appropriate loss function (L), optimizer (O), learning rate (LR), and batch size (B). The performance of the model is evaluated using Mean Absolute Error (MAE) and Mean Absolute Percentage Error (MAPE) as given by, respectively in Equations 4 and 5 (FIG. 34), for metric M with baseline Mb, where n is the number of total samples in the overall dataset.

In addition, to account for the heavily skewed data that commonly results from the execution of various physical design algorithms, the worst 1% MAE and MAPE are used to characterize the performance of the model on the tail data of a standard normal distribution. The performance metrics can be expanded to include a broader range of evaluation in addition to MAPE and MAE.

4) Feature Importance Ranking Using Sensitivity Analysis: Sensitivity analysis evaluates feature importance in a machine learning model by leaving one feature out of each trained model. Primary features are identified that significantly influence the accuracy of the model, while also analyzing potential noise in the model, irrelevant features, and highly correlated features. Removing ineffective or redundant features based on sensitivity analysis enhances model performance by reducing overfitting and improving interpretability. The technique offers valuable insights to fine-tune and optimize the configuration of a model for better predictive performance.

### Application to IC Design Automation

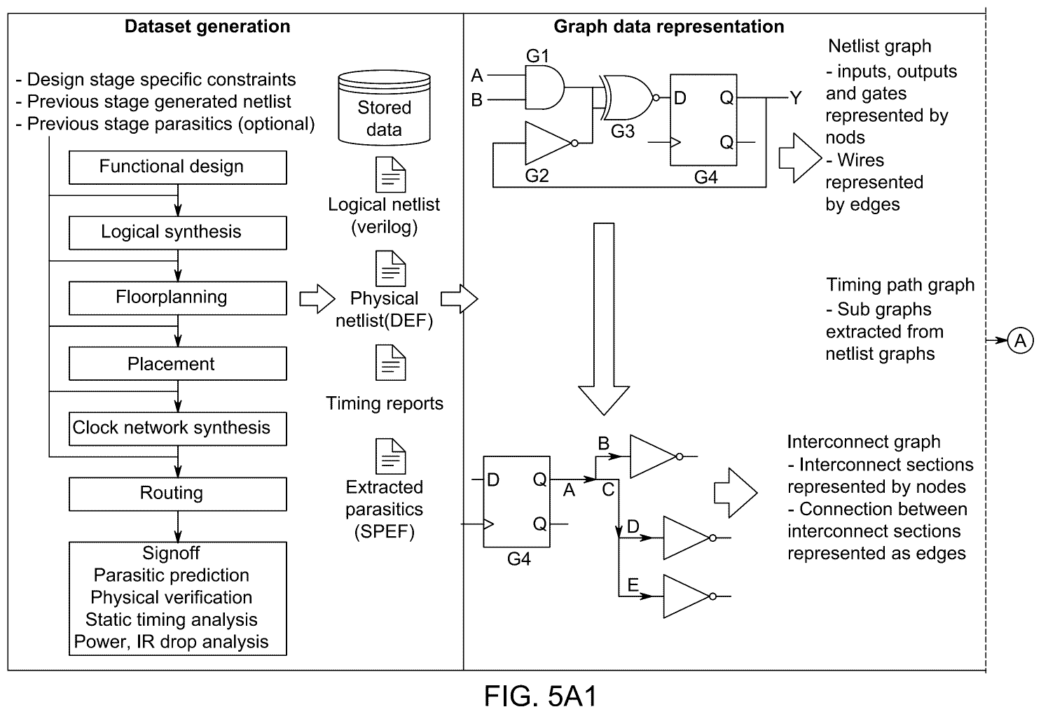

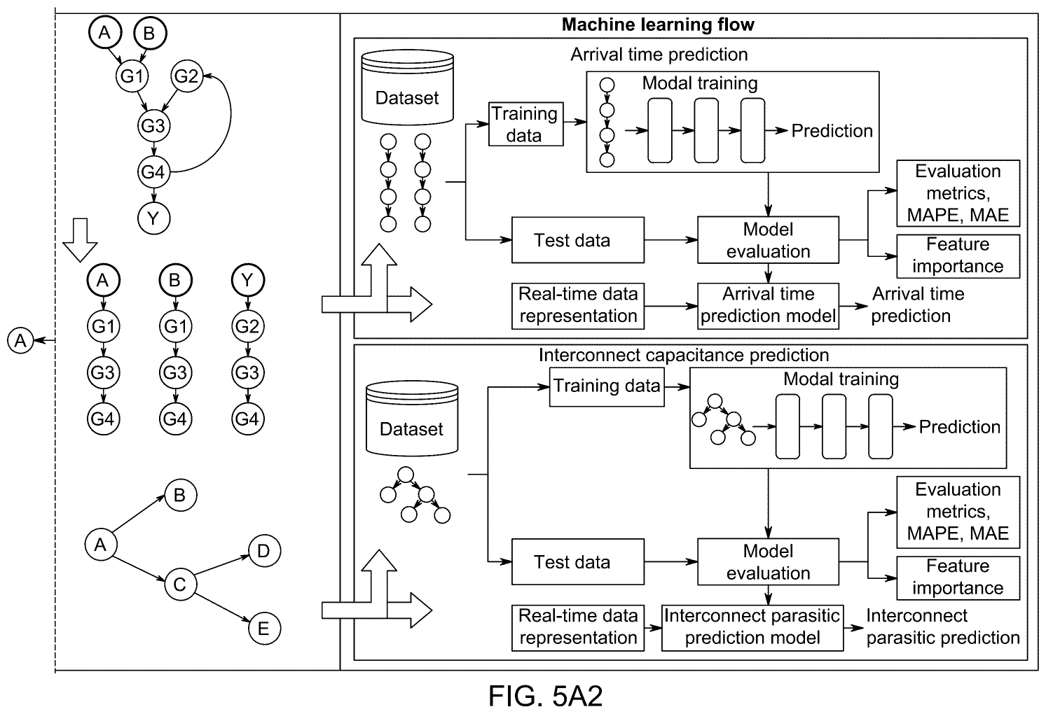

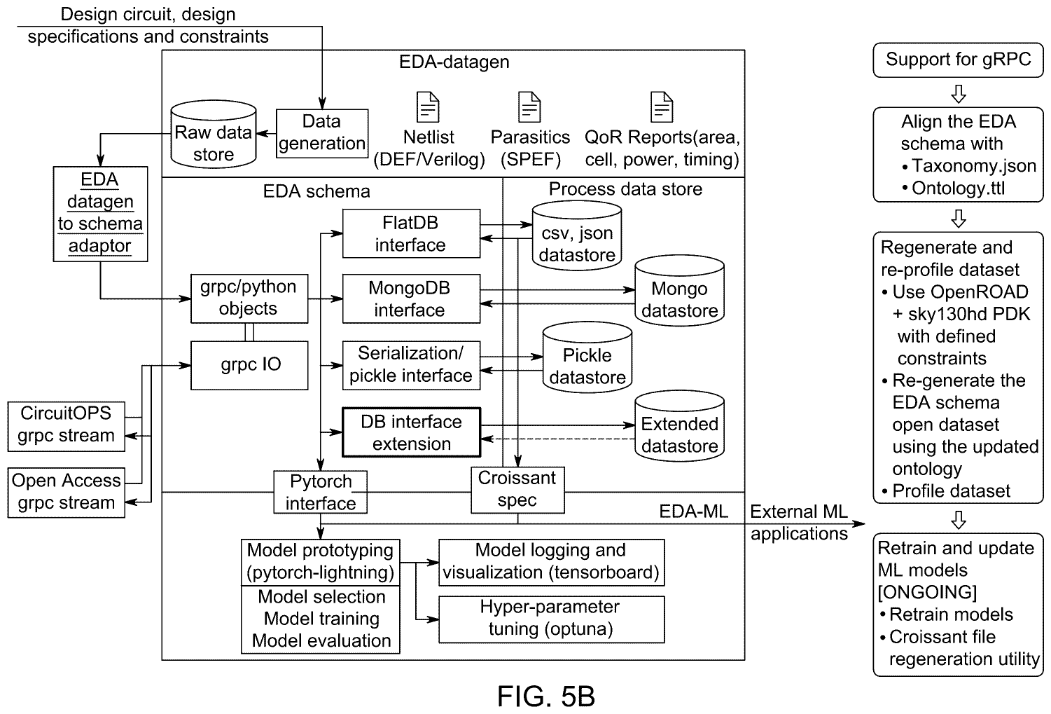

The effectiveness of the proposed graph learning framework is evaluated through two case studies, which demonstrate the capability of solving downstream prediction tasks. The overall execution of the framework and training process is shown in FIGS. 5A and 5B. A dataset of physical designs and timing profiles (i.e. STA) for the IWLS benchmark circuits is generated and used as input for the two case studies that follow.

### A) Dataset Generation

A dataset of layouts is constructed for six IWLS'05 sequential benchmark circuits, which are listed in Table IV, shown in FIG. 22. The dataset is generated on a 28 nm technology node. The benchmark circuits are initially synthesized into technology specific gate-level netlists using Synopsys Design Compiler. The gate-level netlists are then placed and routed into final layouts using Synopsys IC Compiler. Once physical design is complete, static timing analysis is performed using Synopsys PrimeTime. The circuits are designed to achieve an operating frequency of 1 GHz, while constrained to an aspect ratio of 0.5, and an area utilization of 70%.

### B) Case Studies

The dataset is used to analyze two distinct downstream metric prediction problems: post-floorplan to post-routing arrival time prediction and post-placement to post-routing prediction of interconnect parasitic impedance. Extending prior work, the case studies include a larger feature set and use a dataset generated on a 28 nm technology node.

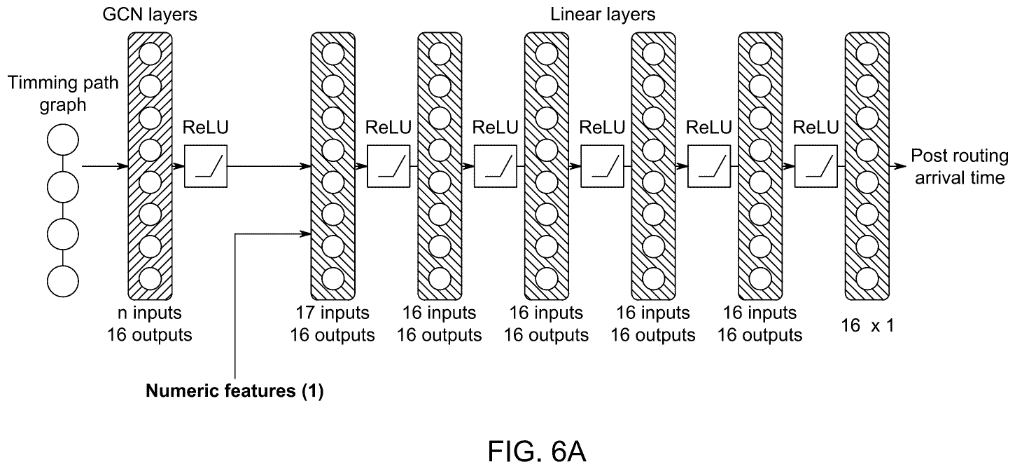

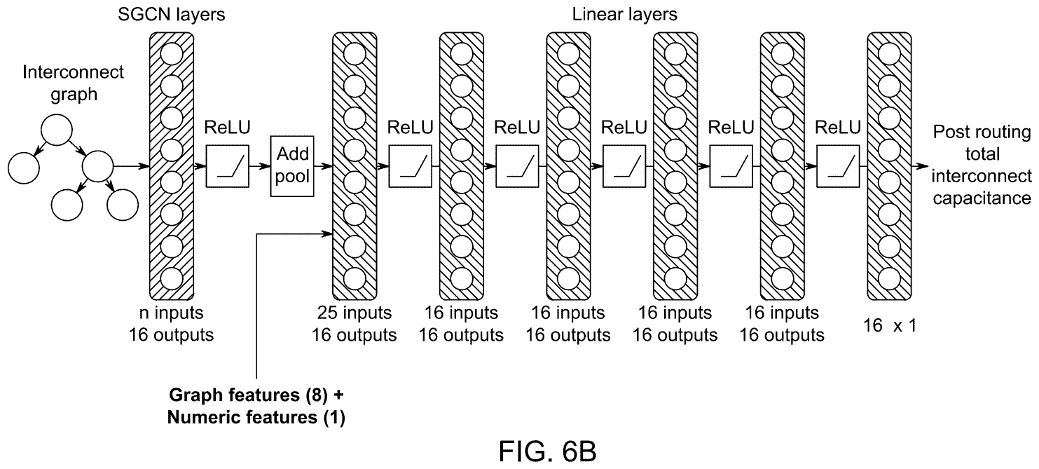

The network architecture for arrival time prediction is depicted in FIG. 6a, while the network architecture used for prediction of the interconnect parasitic impedance is shown in FIG. 6b. Arrival time prediction requires timing path graphs with node-level aggregation and no pooling. Interconnect parasitic impedance prediction uses interconnect graphs and requires pooling to predict the total capacitance of a net. Arrival time prediction uses GCNs for encoding due to a lack of spatial information in the early stages of physical design, while interconnect parasitic prediction uses SGCNs. Both case studies use six linear layers of size 16, with each hidden layer incorporating a rectified linear unit (ReLU) as an activation function. Numeric features, including the baseline, are added to both networks.

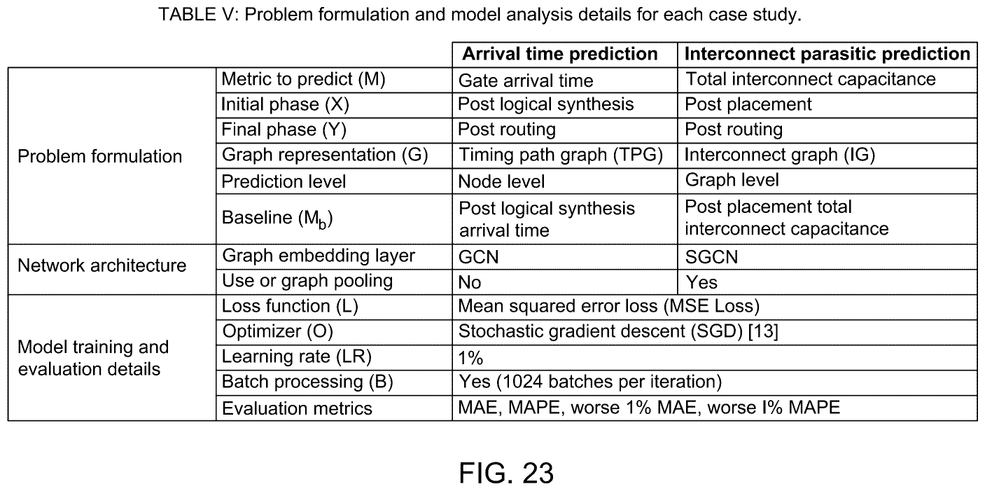

The dataset from the six circuits listed in Table 4 (FIG. 22) is divided into six instances of the neural regression model, where each model includes one circuit as the test set and the remaining five circuits as the training set. Details regarding both the setup for the training of the model and the evaluation of the model are provided through the parameters listed in Table 5 (FIG. 23). The implementation of the framework is in Python 3, using the PyTorch-geometric deep learning library. The training is performed on a system with 96 GB memory, twenty-four 4 GHz CPU cores, and an NVIDIA GeForce GTX 3090 graphics card.

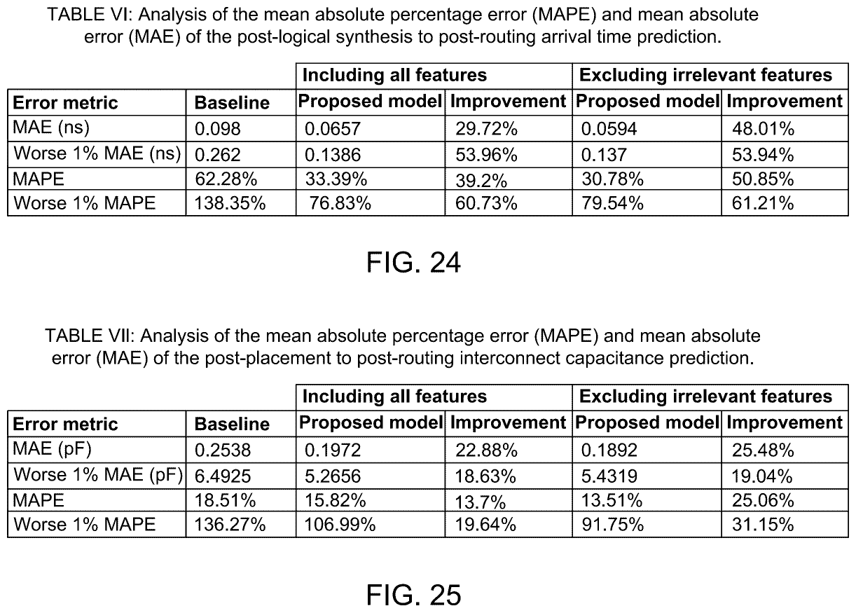

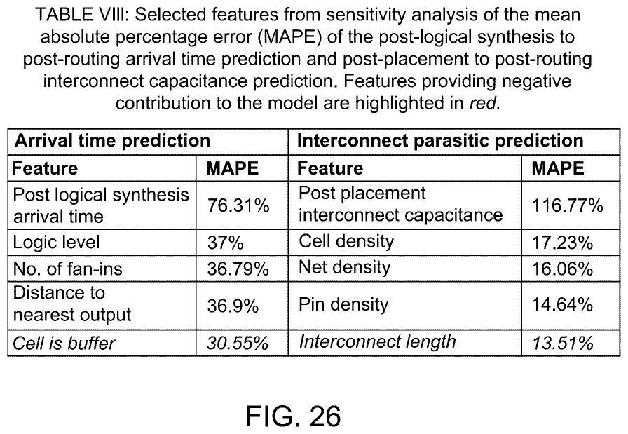

The trained models are validated against the test datasets. The MAPE, MAE, and the MAPE and MAE of the top 1% of worse case errors averaged across the results produced by each of the trained models when predicting on each circuit are listed in Table 6 (FIG. 24) and Table 7 (FIG. 25) for arrival time prediction and parasitic impedance prediction, respectively. Results from a comprehensive sensitivity analysis of feature importance based on average MAPE are listed in Table 8 (FIG. 26).

1) Arrival Time Prediction: The proposed model outperforms the baseline errors provided by PrimeTime, achieving an average improvement of 39.2% in the MAPE score and 29.72% in the MAE score across the six models. In addition, for worse case predictions, the improvement is even more significant, with the proposed model providing an average improvement of 60.73% in the MAPE score and 53.96% in the MAE score over the baseline for the top 1% of arrival times with the largest estimated errors.

The sensitivity analysis reveals the significant impact of specific features on the performance of the model. Arrival time for the initial phase X emerges as the most impactful feature, followed by the position of the gate in the timing path, which represents a structural feature of the circuit and graph. In addition, removing the buffer feature improves the performance of the model. By eliminating features that introduce noise, lack relevance, or exhibit high correlation, the accuracy of the model is improved, and the risk of overfitting is reduced, which results in greater performance and interpretability. The evaluation of the models after removing the ineffective feature (is buffer) is performed, with results listed in Table 6 (FIG. 24). The average MAE and MAPE of the models after removing the buffer feature improves from 65.7 ps to 59.4 ps and 33.39% to 30.78%, respectively.

2) Prediction of Interconnect Parasitic Impedance: The proposed model outperforms the baseline predictions provided by IC compiler, achieving an average improvement of 13.7% in the MAPE score and 22.87% in the MAE score across the six models. For worse-case predictions, the proposed model provides an average improvement of 19.74% in the MAPE score and 18.63% in the MAE score over the baseline for the top 1% of nets with the largest error in estimated parasitic impedance.

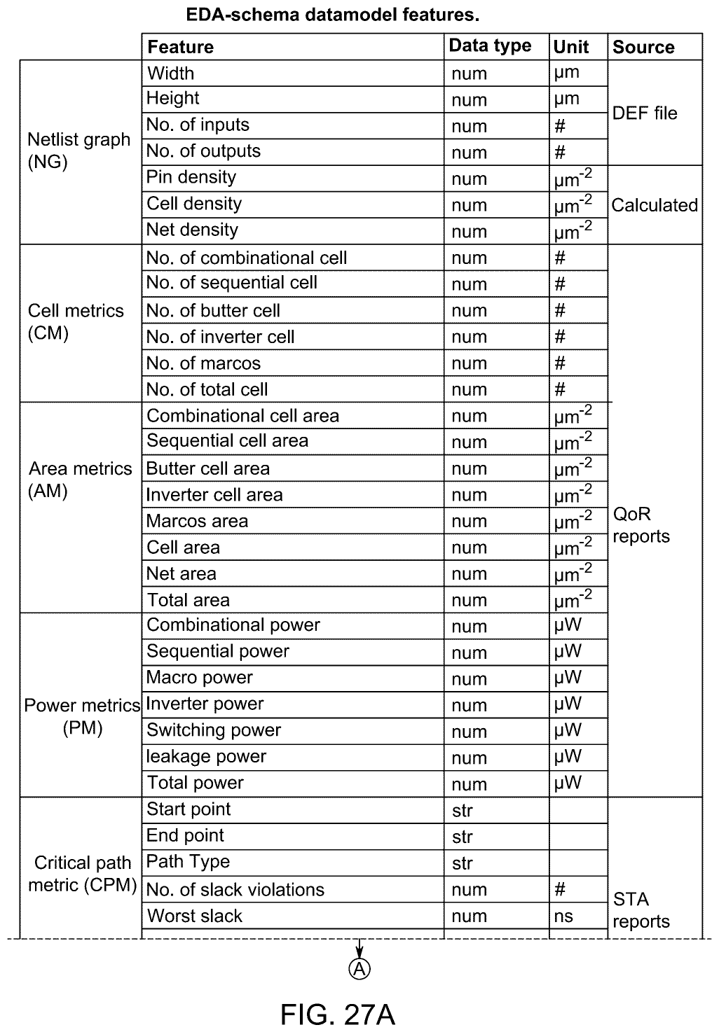

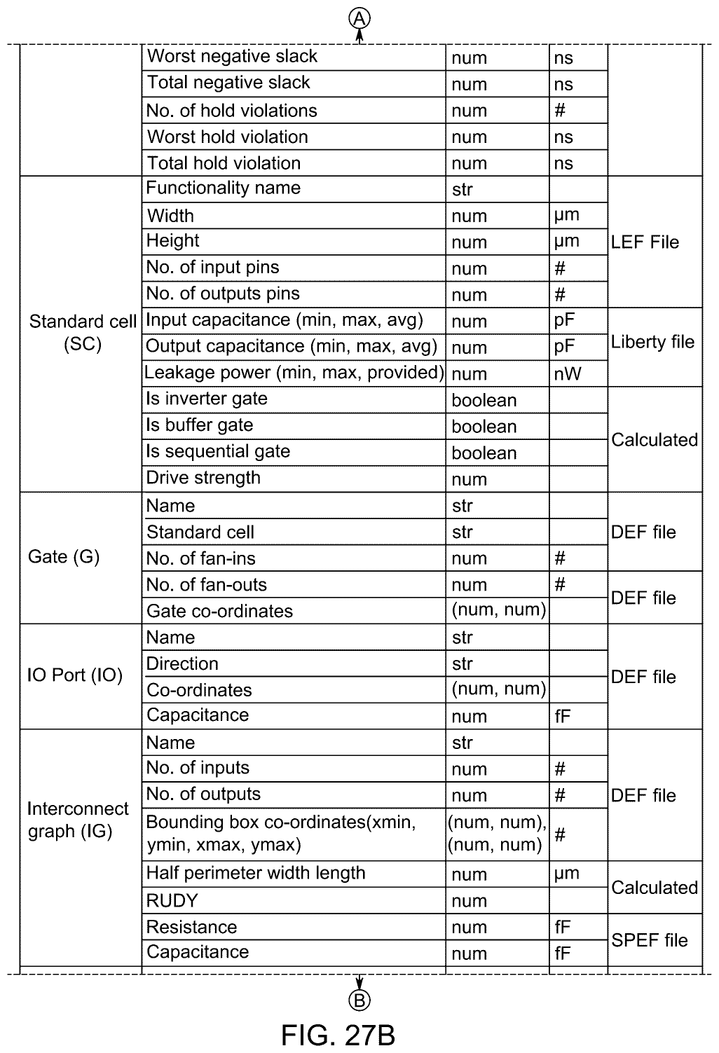

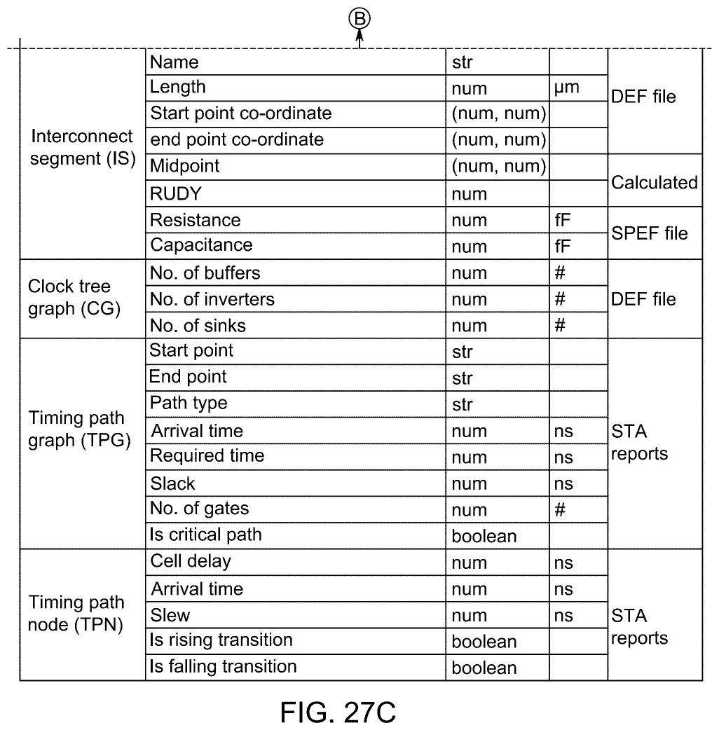

The most significant feature that improves model performance when predicting parasitic impedance is the post-placement estimate of interconnect capacitance. Removing the length of an interconnect as a feature also improves the performance of the model as the interconnect parasitics are already correlated with the interconnect length. The evaluation of the models after removing the interconnect length is performed, with results as listed in Table 7, FIG. 27. The average MAE and MAPE after removing the ineffective feature improves from 197.2 fF to 189.4 fF and 15.82% to 13.51%, respectively.

This section introduces EDA-ML, a task-agnostic graph representation learning framework for IC design automation, which effectively captures complex relationships within graph-structured data and leverages machine learning techniques for downstream metric prediction tasks. The proposed standardized graph representations and feature sets outperform reported baseline errors for two distinct prediction tasks, providing significant improvements in both MAPE and MAE scores. An improvement in MAE of 28.71% and an improvement in MAPE of 39.2% is observed for arrival time prediction, and an improvement in MAE of 22.88% and an improvement in MAPE of 19.64% is observed when predicting for parasitic impedance. Additionally, a sensitivity analysis is conducted on the feature sets to examine the contribution of each feature to the model's performance. Ineffective features are removed from the model as a result of the sensitivity analysis. The removal of the ineffective features when predicting arrival time further improves the MAE and MAPE to 48.01% and 50.86%, respectively. Similarly, removal of ineffective features improves the MAE and MAPE of parasitic impedance prediction to 25.48% and 25.06%, respectively. Overall, the proposed ML framework provides a means to improve integrated circuit design and paves the way for future advancements in design automation methodologies for both research and industry.

### II. Detailed Description for EDA-Schema: A Graph Datamodel Schema and Open Dataset for Digital Design Automation

### Electronic Design Automation Flow

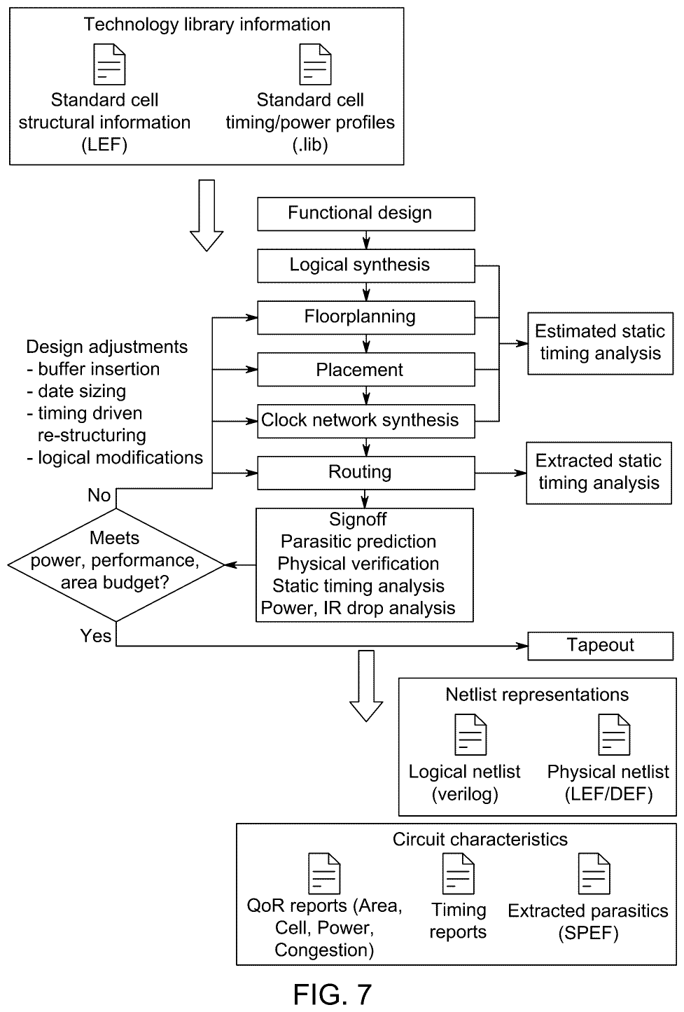

The automated design of a digital circuit is a comprehensive process that includes various stages that facilitate the efficient and functionally accurate implementation of an integrated circuit while meeting target power, performance, and area (PPA) specifications. PDKs, which provide technology-specific data and design guidelines, are fundamental to the design process. EDA tools use PDK information when executing design and optimization algorithms to generate circuit topologies and layouts, while calculating PPA metrics from the generated circuits to meet target specifications. The overall EDA design flow, as shown in FIG. 7, is divided into five critical stages: logical synthesis, floor planning, placement, clock network synthesis, and routing. Each stage depends on design constraints and outputs generated from the preceding stage. Constraints are often stage-specific, further impacting the design of the circuit. Various data formats are used to represent the different aspects of the circuit, often adhering to standard data structures. Typically, the completion of each design phase results in the generation of the following files.

1) Logical Netlist: Technology-specific verilog or VHDL files that use standard cells defined in the liberty files (.lib) of a process technology node and are logical representations of the netlist. Liberty files provide detailed timing and electrical properties of digital standard cells for a specific PDK, which are used to optimize a circuit and verify that design constraints are met.

2) Physical Netlist: Library Exchange Format (LEF) and Design Exchange Format (DEF) files are technology-specific netlist representations that include physical coordinates of input/output pins, standard cell placements, and interconnect routing.

3) Interconnect Parasitics: Standard Parasitic Extraction Format (SPEF) files contain information on the parasitic impedance of a circuit; specifically, the resistance (R), inductance (L), and capacitance (C) of the devices and interconnects of a circuit layout. Interconnects are segmented into sections and RLC values are reported for each section, which enables accurate analysis of signal timing and power consumption. While an estimation of the parasitic impedance can be obtained after placement, the true parasitic impedance of the interconnect is determined after completion of routing.

4) Quality-of-Results (QoR) reports: QoR reports track design quality metrics at each stage of the physical design flow, with reports after logical synthesis providing initial, but inaccurate, estimates of power consumption, occupied area, and timing. More accurate metric scores are obtained in subsequent stages of the design flow.

Timing reports: Timing reports are generated using a static timing analysis (STA) tool. The report includes information on timing paths, arrival time, and required time. Multiple timing paths are extracted from a single circuit.

### EDA Datamodel Schema

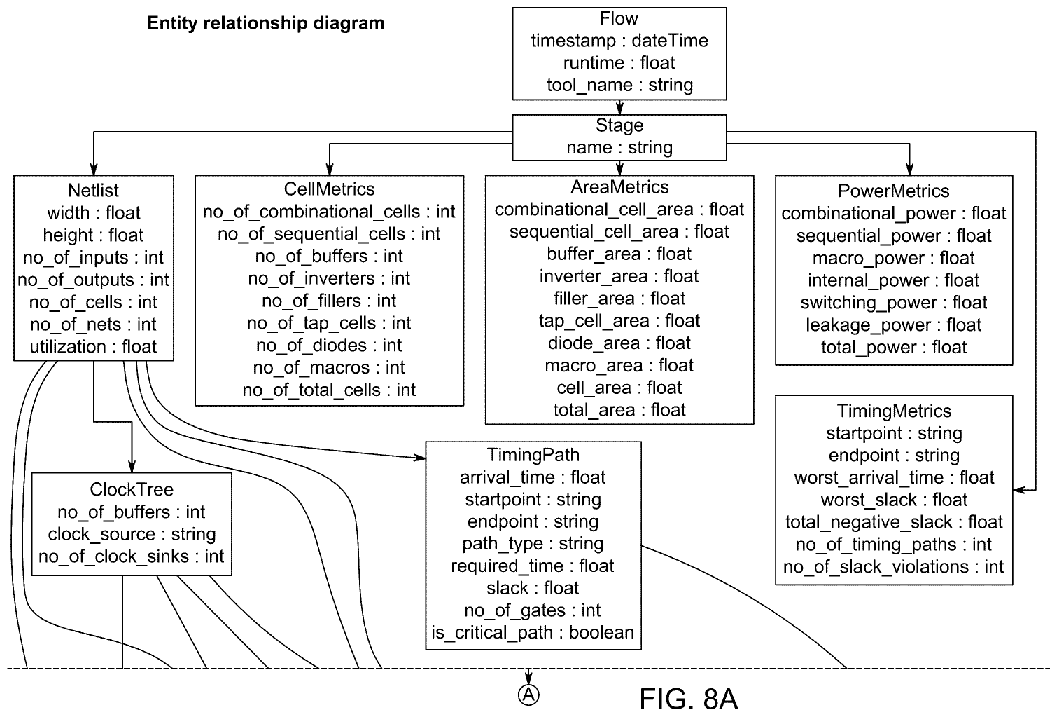

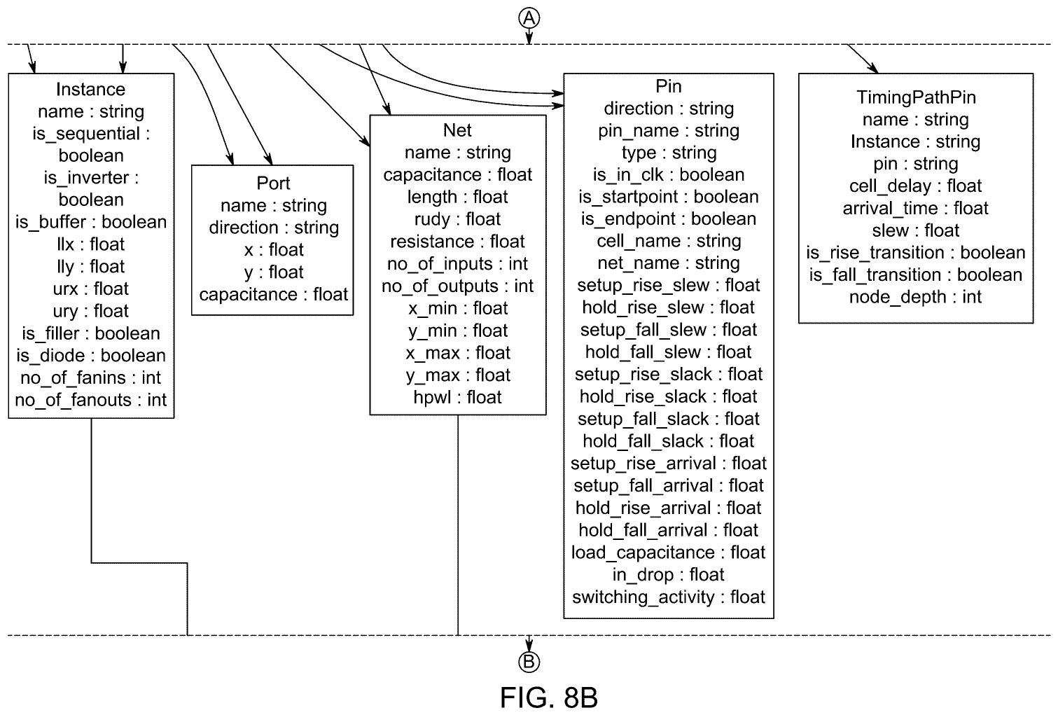

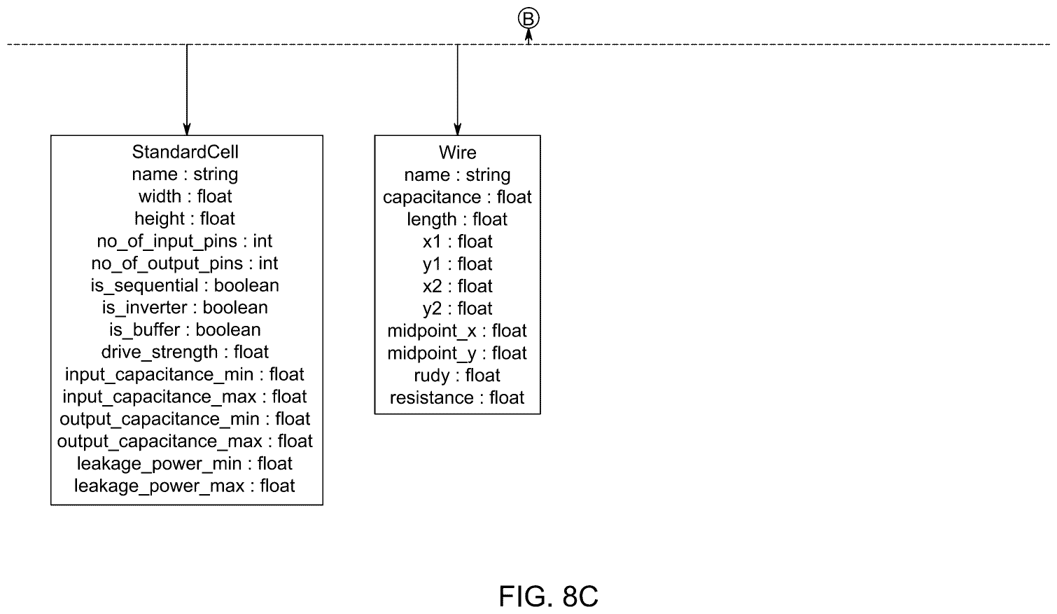

Two types of data results are returned by the executed algorithms of the physical design flow, which are used to assess metrics evaluated on each circuit: (1) structural data of the circuit (.lib, LEF, DEF, and SPEF files), and (2) QoR metrics (power, timing, and area reports). EDA-schema, a property graph data model, represents circuits and subcomponents as directed graphs. Nodes in the graph represent both the interconnects and electronic components, including gates and passive devices, while edges represent the connections between these components. The netlist, clock network, interconnect, and timing path are primary graph entities of the circuit and schema, with each described herein. Each node and edge in the graph contains structural features, QoR metrics, and derived features. The features of sub-components of a graph that are not graphs themselves are stored as tabular entities associated with the primary graph entities. An entity relationship diagram for the schema is shown in FIG. 8, and entity properties are listed in Table 9 (FIGS. 27a and 27b).

### 1. Netlist

Verilog and DEF files provide structural details on logic gate functionality, input/output port properties, coordinates of the placed devices, and interconnect routing paths. The extracted information is mapped to a heterogeneous netlist graph, denoted as NG=(V, E), where nodes v∈V represent input/output ports (IO), gates (G), and interconnects (I) , and edges e∈E denote connections between devices and components of the circuit. In addition to the structural and topological details obtained from DEF files, the netlist entity includes density features as attributes, which are calculated as
pin density=number of pins in circuit/area of circuit
cell density=number of gates in circuit/area of circuit
net density=number of interconnects in circuit/area of circuit

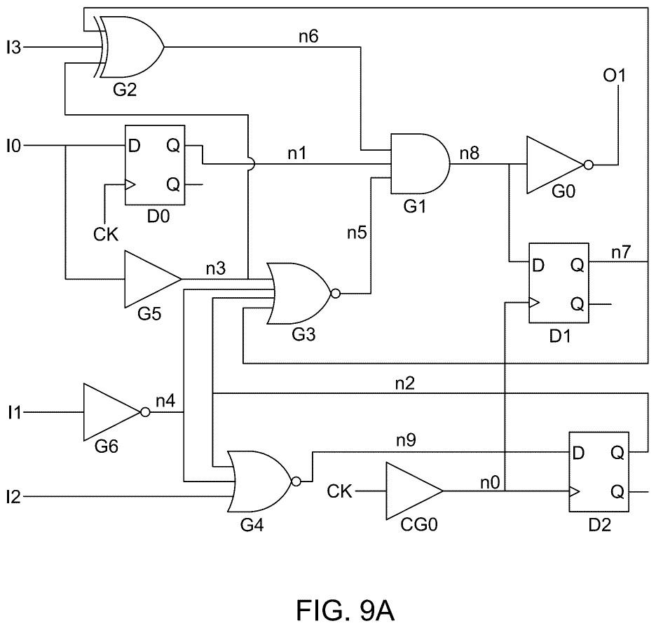

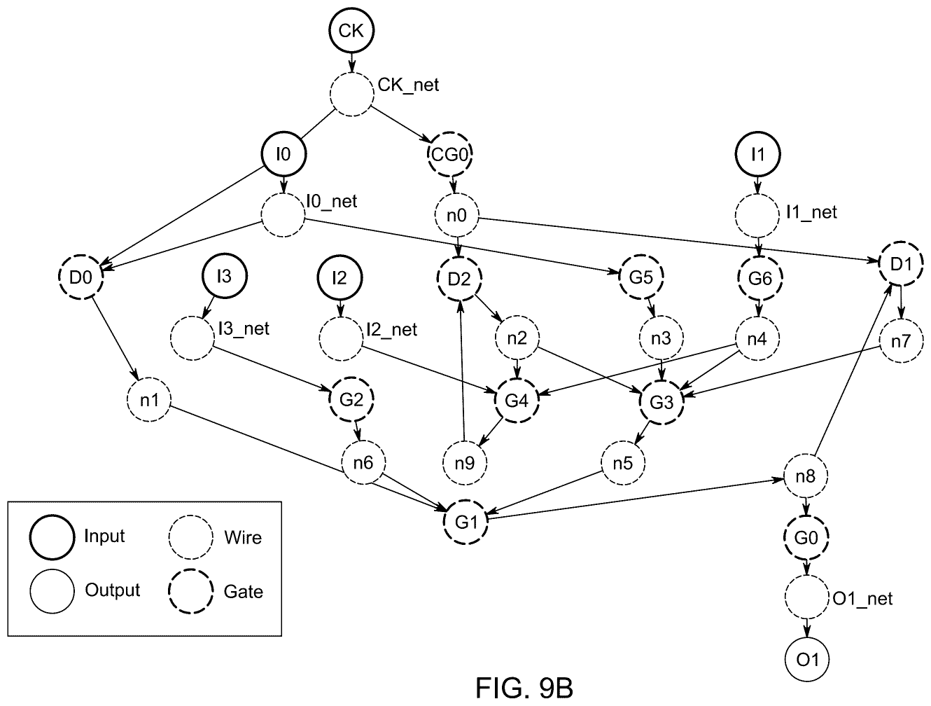

As an example, the netlist graph for the circuit depicted in FIG. 9a is shown in FIG. 9b.

Gate nodes extend standard cells (SC) with design-specific structural and positional attributes. LEF files provide structural features, while the liberty files describe the timing and power profiles of the standard cells. A range of capacitance and power numbers is provided in a .lib file for each gate, with the value contingent upon the logical conditions of the applied input and the pins of the standard cell. The information provided by the various files is mapped to a standard cell entity.

Quality metrics that extend the netlist graph, including the cell count, area, and power consumption, are extracted from QoR reports and are listed in Table 9 as Cell Metrics (CM), Area Metrics (AM), and Power Metrics (PM), respectively. Critical path information from the timing reports, provided as the Critical Path Metric (CPM), further extend the attributes of the netlist.

### 2. Clock Network

Clock networks are substructures derived from the netlist. Clock network graphs (CNG), similar to netlist graphs, are comprised of nodes v∈V that represent input/output ports (IO), gates (G), and interconnects (I) , and edges e∈E that denote connections between components. Notably, the attributes of the clock network entity are distinct and specifically pertain to clock-related information. The clock network graph for the circuit depicted in FIG. 9a is shown in FIG. 10.

### 3. Interconnect

The structural properties of an interconnect entity (I) are extracted from the DEF files, while the parasitic impedance is extracted from the SPEF files. Physical representations are also used to calculate derivative properties, including the interconnect wire length, half perimeter wire length (HPWL), and Rectangular Uniform wire DensitY (RUDY), which is a metric used to evaluate routing resource utilization and congestion.

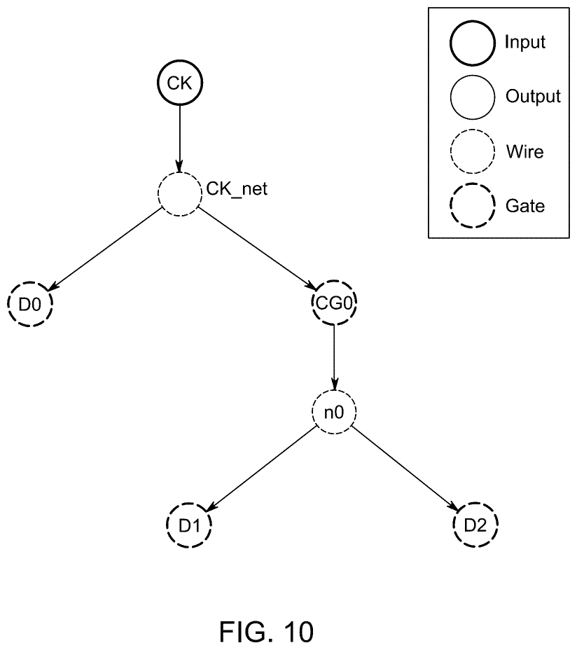

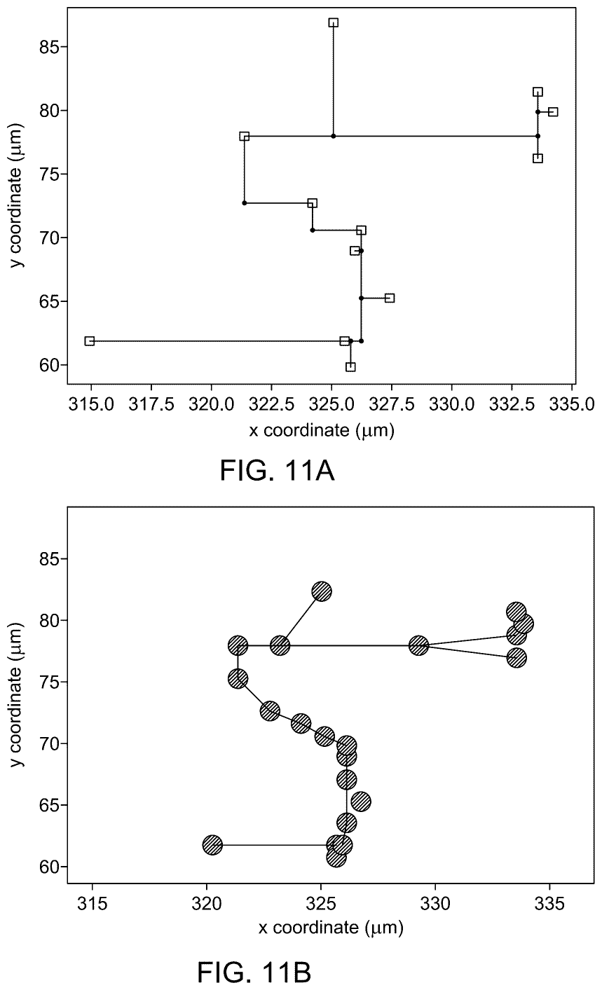

To comprehensively analyze the physical characteristics of the circuit interconnects, detailed properties of estimated interconnect segments and the corresponding spatial relationships are extracted from the netlist graph. While the true physical characteristics of the interconnect only become available after routing, the insertion point and the destination point of the interconnects are available after placement, which allows for an estimate of the routing paths of a circuit post placement. The physical representation of the estimated interconnect paths is extracted from the DEF file generated after placement, with an example of an interconnect path shown in FIG. 11. The properties of the nets are parsed and mapped on to an interconnect graph IG=(V, E), where nodes v∈V represent interconnect segments and edges e∈E represent connections between two or more interconnect segments. The interconnect graph captures the spatial layout and connections of the circuit. An example of an interconnect graph is shown in FIGS. 5A and 5B, with each node of the graph populated with the feature set listed in Table 10, FIGS. 27a and 27b. The features of the parasitic impedance and the impedance of the interconnect segments are obtained from the SPEF file.

### 4. Timing Path

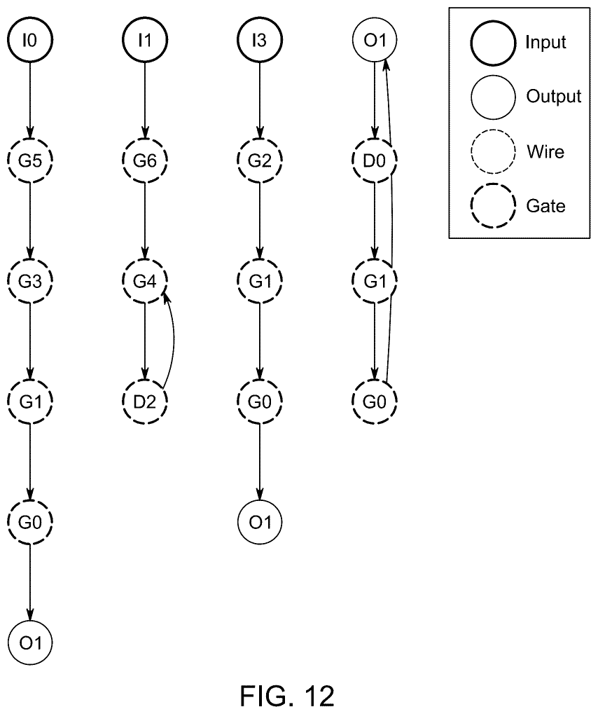

Static timing analysis (STA) is a crucial step that ensures timing constraints are met by identifying critical signal paths (timing paths), and computing the arrival and required times of the identified paths. Assuring the identified critical paths meet timing constraints is essential for the overall optimization of the performance and reliability of a circuit. Subgraphs representing timing paths, described as timing path graphs T PG =(V, E), are shown in FIG. 12. The T PGs are derived from the netlist graph NG. Nodes of a timing path subgraph are either gates G or interconnects I appended with timing features extracted from the STA generated timing reports and mapped to the circuit netlist.

### Graph Types and Representations

In addition to netlist graphs, timing path graphs, and interconnect graphs, the present disclosure contemplates clock network graphs and hybrid or fused graph representations that combine structural, timing, and parasitic information into a unified model. Fused multi-graphs may include aligned node identifiers allowing multi-modal feature aggregation.

### Feature Categories and Processing

Features are grouped into three principal categories:
Structural features such as gate type, drive strength, number of fan-in/fan-out connections, and derived connectivity measures.
Spatial features such as physical coordinates, half perimeter wire length (HPWL), and Rectangular Uniform wire DensitY (RUDY)
Performance metric features such as timing slack, arrival time, power, and parasitic impedance values.

Feature values may be normalized across technology nodes using scaling factors based on process parameters (e.g., feature size, resistance per unit length). Synthetic features can be generated via simulation or statistical modeling to augment measured or extracted features.

### Machine Learning Models

The prediction framework may employ single GCN or SGCN models, or ensembles thereof, with each network trained on different feature subsets or graph types. Composite loss functions, such as a weighted combination of mean absolute error (MAE) and mean absolute percentage error (MAPE), may be used to balance absolute and relative accuracy.

### Multi-Stage and Iterative Prediction

The framework supports prediction across multiple intervals in the design flow, e.g., from post-floorplan to post-placement, and from post-placement to post-routing, or directly from post-floorplan to post-routing. Predictions can be iteratively updated as additional design stages are completed.

### Data Schema Interoperability

The schema is designed for integration with machine learning workflows, providing ontology-based feature definitions and Croissant-format metadata for standardized description and exchange of datasets. This enables reproducibility, comparability, and extension of datasets across research teams and toolchains.

### Parameterized Dataset Generation

Datasets may be generated by sweeping design parameters including clock period, core aspect ratio, utilization, clock skew, and maximum fanout. Multiple PDKs may be supported, and each dataset entry is stored as a combination of graph entities and tabular entities in the schema format. Benchmark circuits may be drawn from public suites such as IWLS'05, ensuring reproducibility.

### Open Dataset

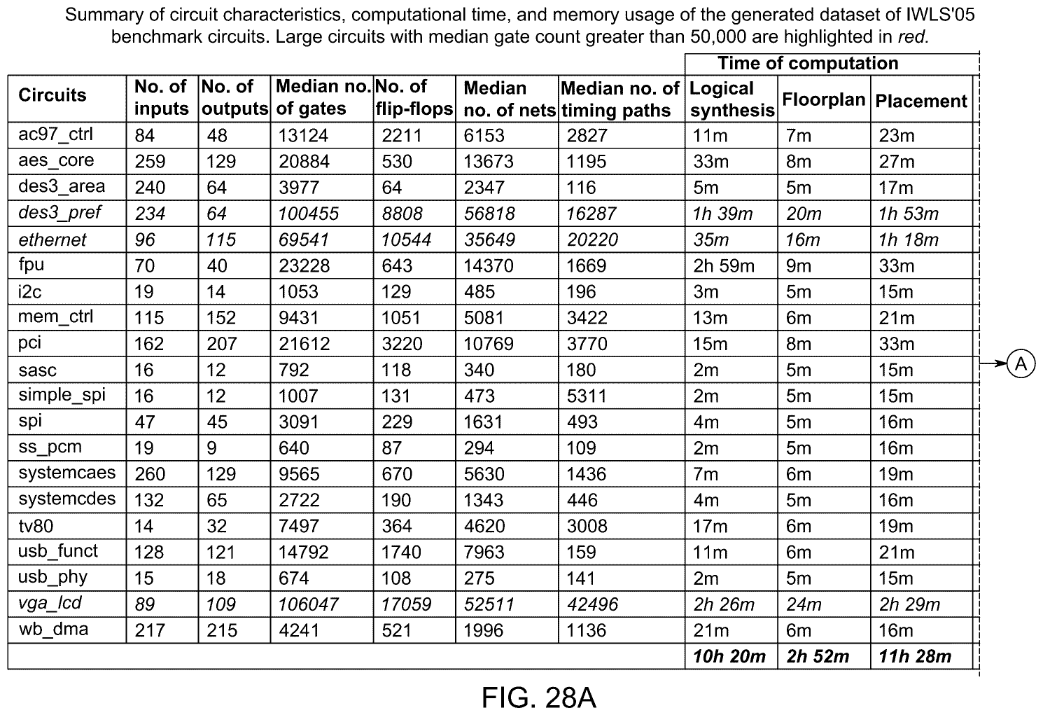

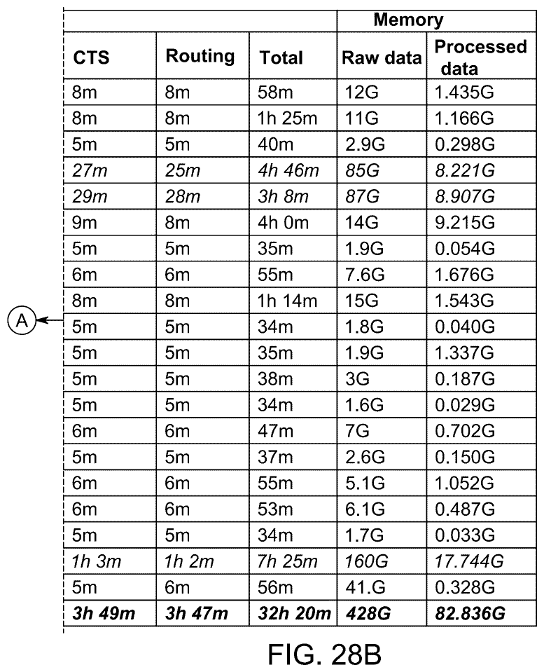

Publication or open profiling of datasets generated using commercial EDA tools and commercial PDKs is often restricted by term of use requirements. Therefore, generating open data by using open-source tools and publicly available PDKs and benchmark circuits is of importance. Use of openly available resources allows for the unrestricted sharing of generated design data and reports from open-source tools, which enables broader research and collaboration. In this section, an open dataset of physical designs is described for the benchmark circuits listed in Table 11, FIG. 28.

### 1. Dataset Generation

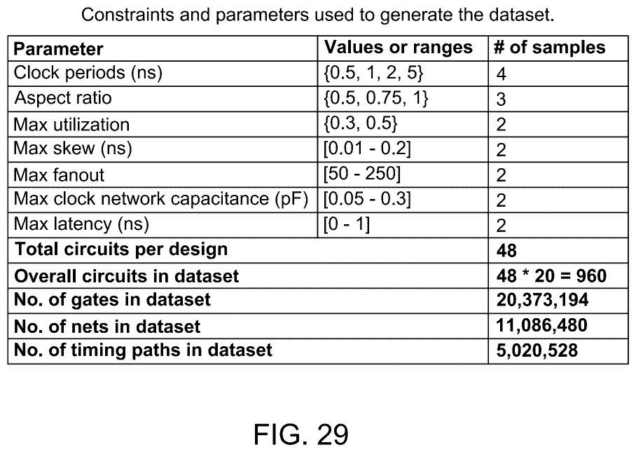

A comprehensive dataset for physical design is comprised of four components: (1) the circuits used to create the dataset, (2) the PDK of the fabrication process, (3) the software tools used for physical design, and (4) a specific set of configuration parameters that govern the generation of the dataset. The open dataset is generated using the IWLS'05 sequential benchmark circuits. A general characterization of the benchmark circuits is provided through attributes listed in Table 11, FIG. 28. The PDK for the Skywater 130 nm technology node is used on the OpenROAD toolset, which is used for physical design and verification. The generated raw dataset is curated and formatted using the EDA-schema described below. Multiple layouts are generated for each benchmark circuit using the parameterized design configurations listed in Table 12, FIG. 29, which results in 960 physical designs, with 48 iterations of each of the 20 benchmark circuits. The 960 physical designs include a total of 20,272,194 gates (including filler cells), 11,086,480 interconnects, and 5,020,528 timing paths after routing. The dataset is generated on a server with 94 GB memory and 4 GHz CPU cores and requires a total of 32 hours and 20 minutes of compute time. The final raw dataset, which contains 428 GB of netlists and performance metric reports, is curated and compressed to 82.83 GB of .csv and .json files formatted using the EDA-schema.

### 2. Dataset Analysis

In this section, an in-depth analysis of the generated dataset is provided. The objective is to characterize key aspects of the dataset while also providing insights into the generated circuits.

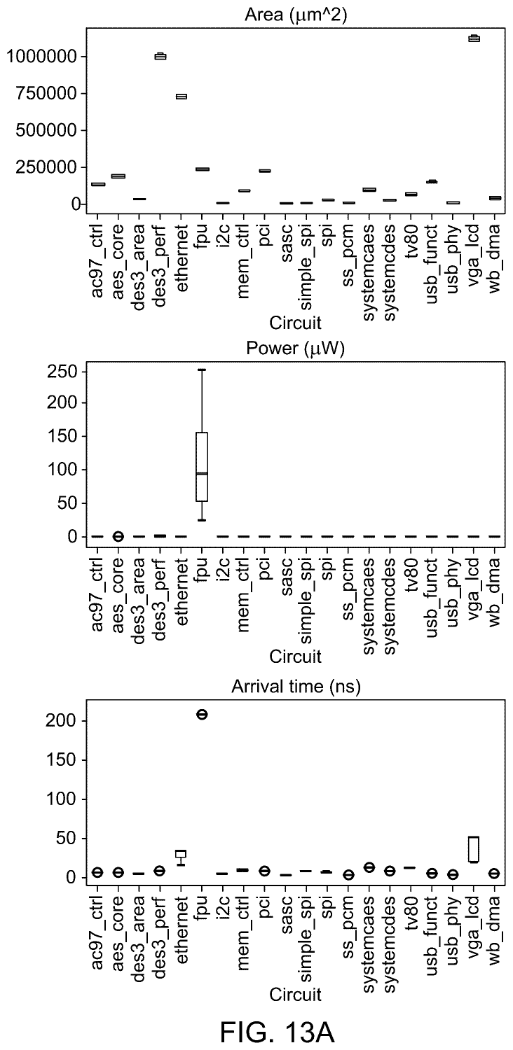

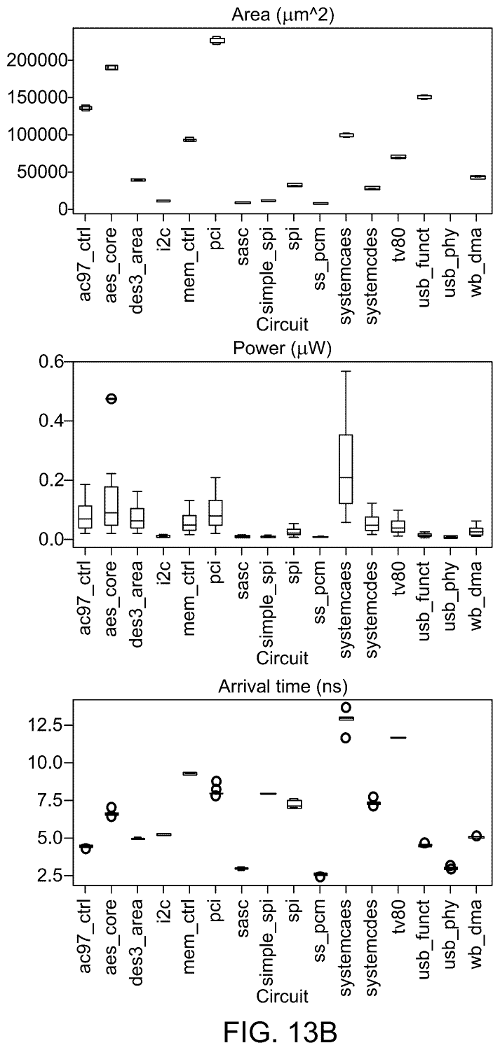

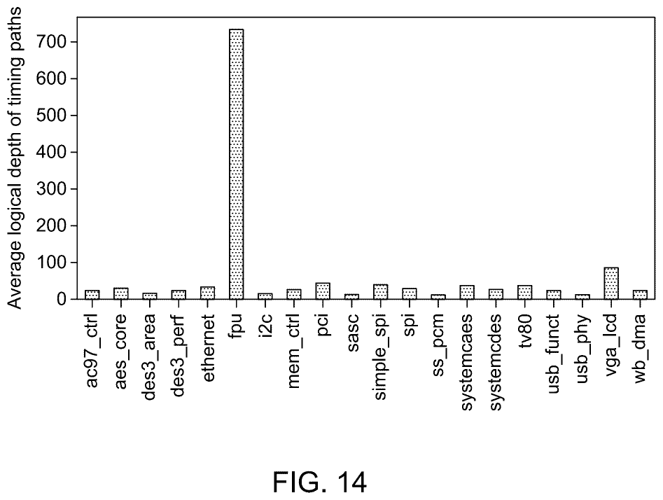

2.1 Power, Performance, and Area Metrics. The distribution of the total area, total power, and worst-case arrival time for each circuit of the dataset after completion of routing is shown in FIG. 13a. The circuits exhibit a large range in the area occupied, which spans from 5,748 μm2 to 1,141,293 μm2, and the total power consumed, which spans from 0.761 nW to 251 μW. Ethernet, des3_perf, and vga_lcd occupy a larger area as compared to the rest of the circuits, with an average area of 999,889 μm2 amongst the three as compared to an average area of 81,421 μm2 for the entire dataset. In addition, the interquartile range of the total power consumption of the 48 instances of the fpu is greater than that of the other circuits, reflecting a higher degree of variation in the power consumed. Although comparable to the rest of the circuits of the dataset based on the area occupied, the fpu on average consumes a significant amount of power (approximately 68× times greater than the next largest power consuming circuit des3_perf) and provides significantly worse performance (approximately 5× times longer worst case arrival time than the next worst circuit vga_lcd). The larger power consumption and the longer worse case arrival times of the fpu are a consequence of the functional complexity of the circuit, as evidenced by the large logical depth of the timing paths of the combinational logic, as shown in FIG. 14.

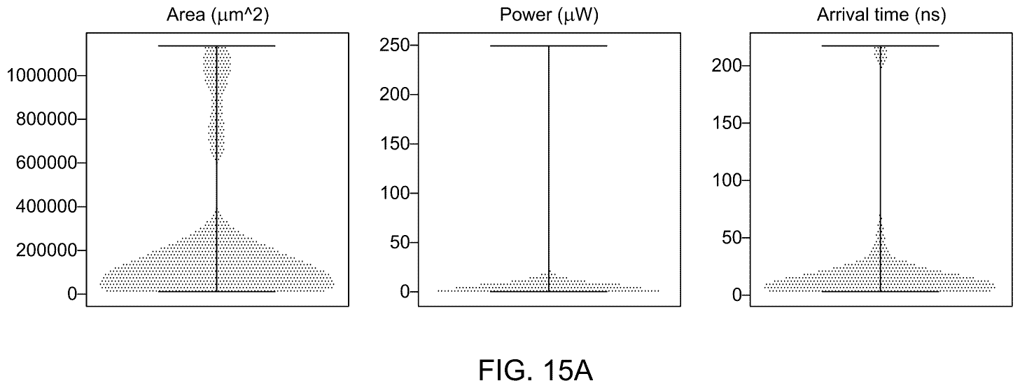

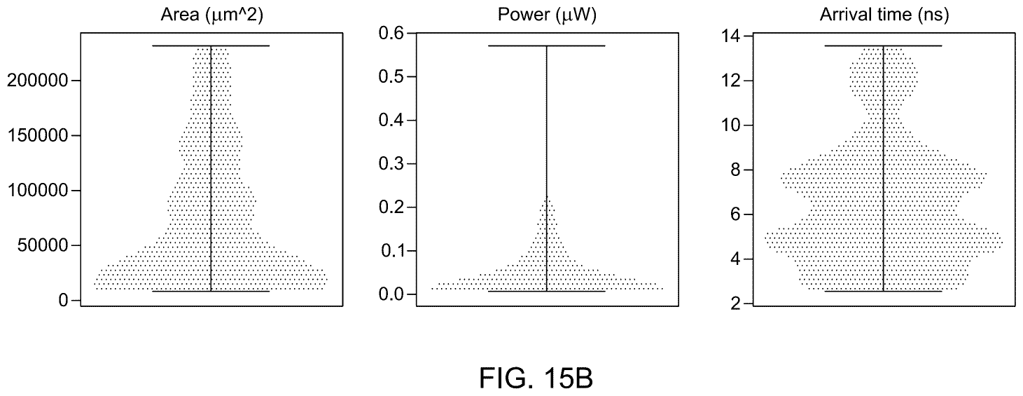

The distribution of the post-routing total area, total power, and worst case arrival time is shown in FIG. 13b for each circuit excluding the fpu and the comparatively larger circuits of ethernet, des3_perf, and vga_lcd. While the excluded circuits offer valuable insights into ‘corner cases’ of generated circuit topologies, the unique characteristics each brings skews the general properties of the dataset. The filtered dataset provides a more targeted set of circuit characteristics. The distribution of the total area, total power consumption, and worst case arrival time post-completion of routing for the complete dataset with and without the fpu, ethernet, des3_perf, and vga_lcd is shown in FIG. 15a and FIG. 15b, respectively. The results indicate that the entire dataset includes considerable skew in area, power, and arrival time. By excluding the selected circuits, the prevalence of outliers is noticeably reduced, which allows for a detailed analysis of the fundamental characteristics of the dataset. The comparison between the entire dataset and the dataset with excluded circuits highlights the effect of ‘outlier’ circuits on the power, performance, and area characteristics of the dataset and underscores the significance of accounting for each factor when designing and analyzing a circuit with ML algorithms.

The variation in circuit characteristics highlights the design trade-offs and optimization strategies needed across the different circuits. Circuit variability is essential for the creation of a comprehensive and generalizable dataset and to assure that a wide range of real-world scenarios are addressed. Providing a comprehensive coverage ensures that the dataset effectively represents the broad range of conditions encountered in circuit design and performance analysis.

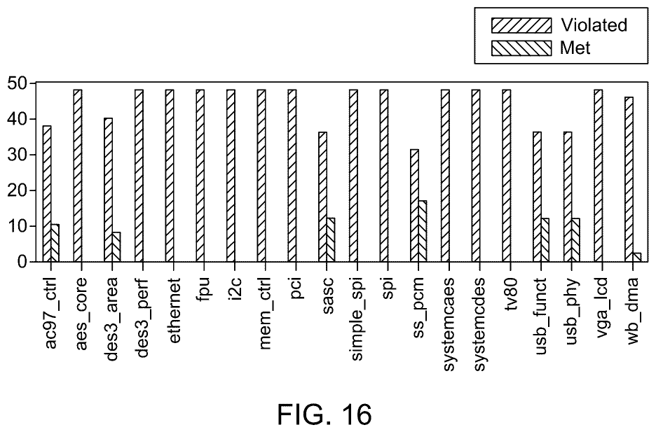

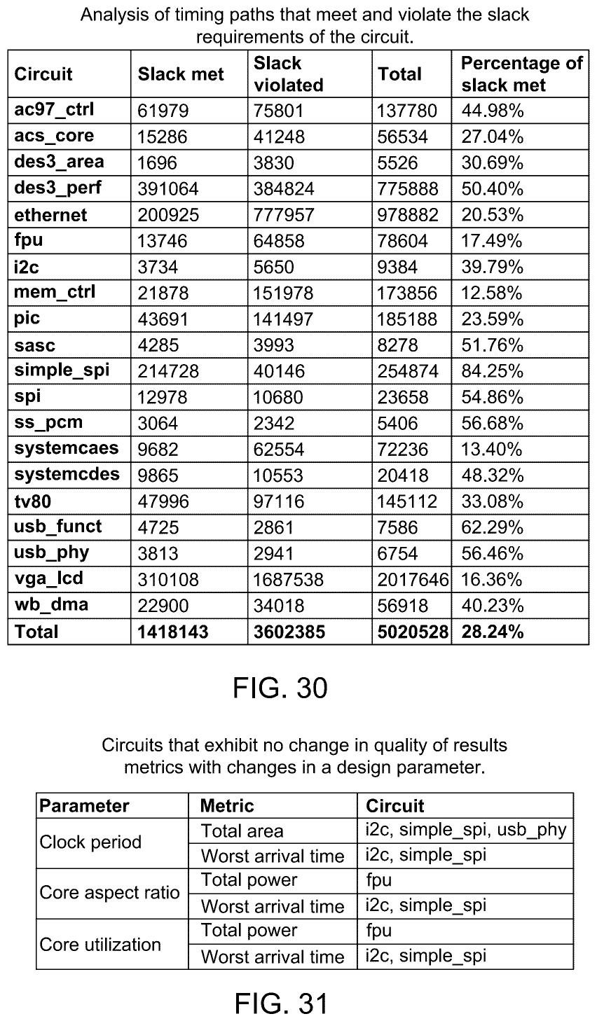

2.2 Timing Analysis. The dataset includes circuits that both comply and violate the targeted timing budget, with 1,418,143 timing paths that meet the timing requirements and 3,602,385 timing paths that do not. The number of timing paths that meet and violate the slack requirements across the different circuits is listed in Table 13 (FIG. 30). Of the 960 circuits generated using the design constraints and parameters listed in Table 12, 73 circuits include timing paths with all slack requirements met. The comparison between circuits with at least one timing path slack violation and circuits with all timing path slack requirements met is shown in FIG. 16. Note that, 71.76% of timing paths violate the slack requirements, while only 7.81% of the circuits include timing paths with no slack violations. However, slack is a comparative metric relative to a target budget. A slack violation does not necessarily indicate a non-functional circuit. The violation only indicates that the circuit does not meet the predefined timing constraints or the targeted clock frequency. Consequently, the circuit potentially functions correctly, but at a reduced clock frequency. The inclusion of timing paths that both meet and violate the timing budget provides a comprehensive range of timing path behaviors and enhances the adaptability and usefulness of the dataset for various analytical and design-oriented use cases.

2.3 Parameter Analysis. An analysis of the effects of clock period, core aspect ratio, and core utilization on key quality metrics (total area, total power, and worst case arrival time) is performed. The characterization of the effects of the parameters on the quality metrics is used to justify the inclusion of a given parameter as a component of the dataset.

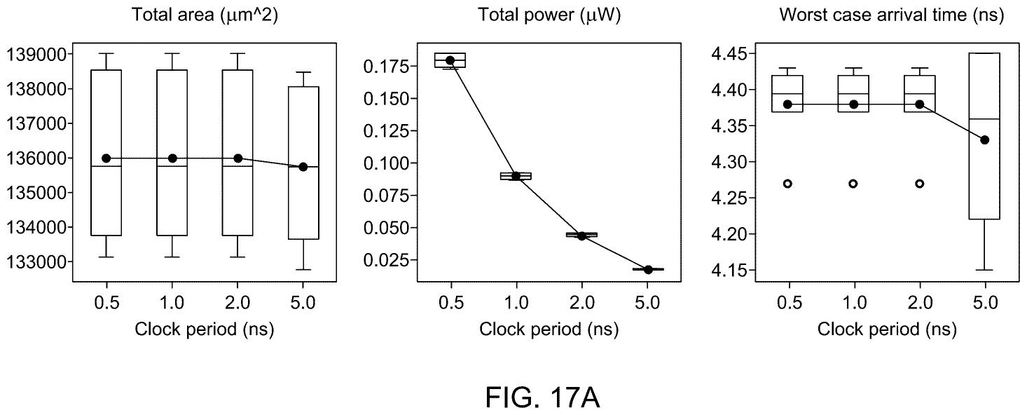

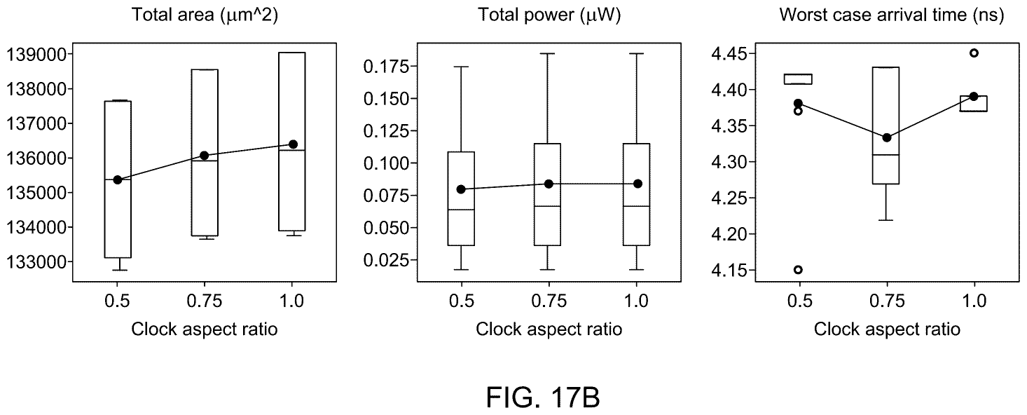

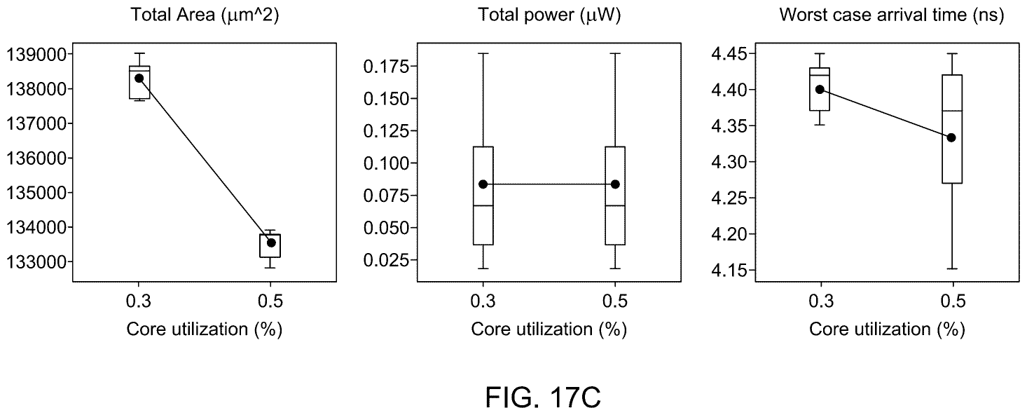

Distributions of the total area, total power, and worst case arrival time as a function of design parameters for the ac97_ctrl circuit are shown in FIG. 17. Results indicate that changes in clock period, core aspect ratio, and core utilization lead to variations in the total area, total power, and worst-case arrival time. The trend lines mark the mean of the total area, total power, and worst-case arrival time of the circuit in relation to variations in the design parameters. Modifications in design parameters lead to observable shifts in mean values, which indicates an influence on the quality metrics of the circuit. The variation in mean values confirm the effect of a given design parameter on evaluated metrics.

To quantitatively characterize the relationship between the design parameters and the quality of results metrics for each circuit, a correlation analysis is performed between the design parameters used to generate each circuit and the mean score of each evaluated quality metric for the generated designs. The Pearson's correlation coefficient r is computed for each parameter-metric pair to determine the strength and direction of the corresponding linear relationships. The Pearson correlation coefficient is given by Equation 6 (FIG. 35), where xi and yi are the values of the two variables being compared, x⁻ and y⁻ are the mean values of each variable, and n is the number of observations.

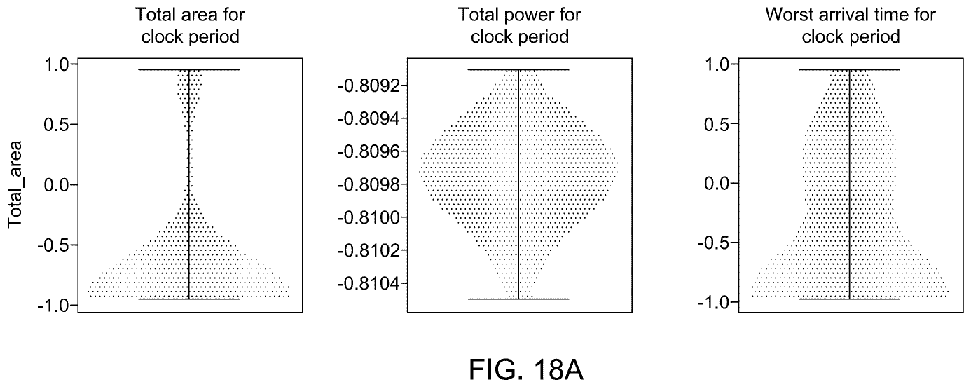

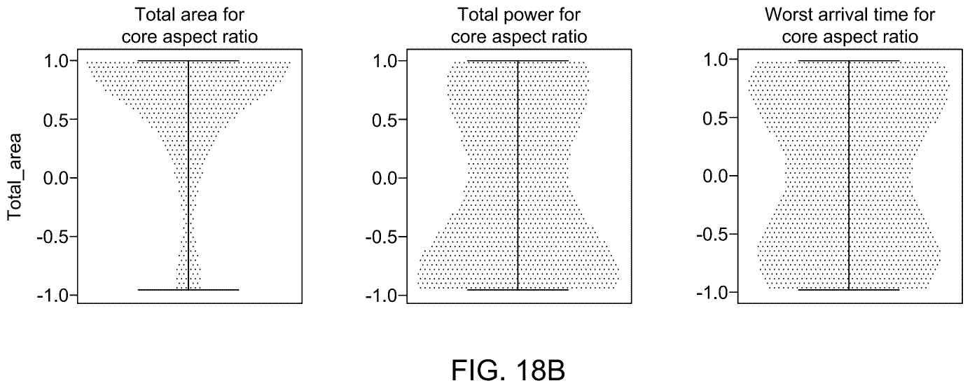

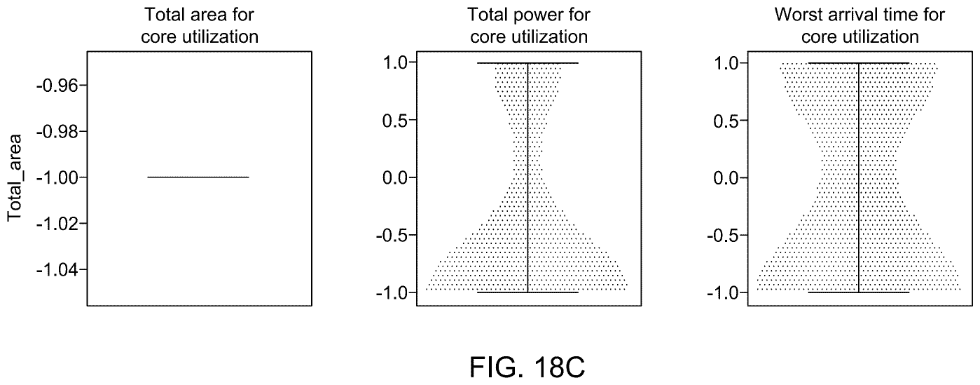

The correlation between the design parameters and the quality metrics for all circuits of the dataset is shown as violin plots in FIG. 18. The analysis of the spread and the shape of the plot for each parameter-metric pair allows for an assessment of the impact of each design parameter on each metric. The skew of the correlation coefficient towards either 1 or −1 indicates, respectively, a significant positive or negative effect on a metric by a given design parameter. The large skew towards the extreme ends of a given metric, instead of around zero, underscores the critical effect each parameter has on the resulting circuit. For example, the total area of a circuit is positively correlated with the aspect ratio and negatively correlated with the target clock period, indicating that both parameters substantially affect the resulting circuit topologies. The core utilization parameter results in a broad range of correlations, with significant skew towards both −1 and 1, while also resulting in values around zero, which suggests a varying impact on circuit PPA. Therefore, some design instances are sensitive to changes in core utilization, while others are not.

The dataset also includes circuits that are unaffected by changes in design parameters. For example, variations in design parameters do not change the critical timing paths of the simple_spi circuit, which indicates that no effect is observed on the worst case arrival time. Circuits that exhibit insensitivity to changes in design parameters are listed in Table 14, FIG. 31.

### EDA Schema for Machine Learning

The primary aim of this work is to provide a foundational dataset for machine learning applications. In Section 1, the datasets and feature sets used in prior research are examined, assessing the effectiveness of the proposed data model in achieving interoperability and comparability. A baseline analysis is described in Section 2 of three prediction tasks that use metrics provided by EDA-schema and an open dataset.

### 1. Feature Set Analysis

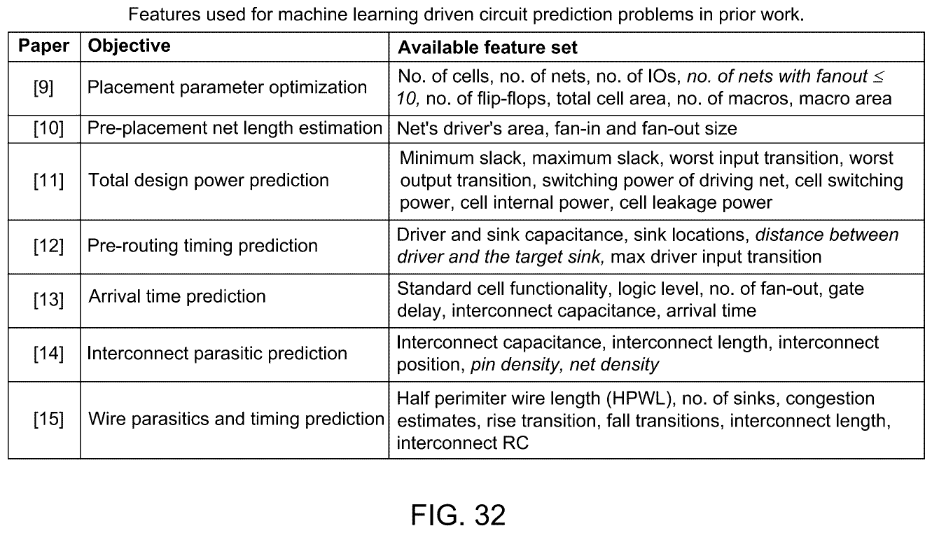

In this section, an analysis of datasets and feature sets used in prior research is provided, which allows for the evaluation of the proposed data model and schema for interoperability and compatibility. An analysis of eight EDA tasks with associated features is performed as listed in Table 15, FIG. 32, with bold features directly available within EDA-schema for ML tasks. In addition, the italicized features listed in Table 15 represent attributes that are not directly included in EDA-schema, but are derived using the provided structures and features, which demonstrates the ability to expand EDA-schema. For example, the number of nets with a fanout of ≤10 is not explicitly listed in EDA-schema. However, a value is calculated by using the interconnect fanout feature. Similarly, metrics including the distance between a driver cell and target cells as well as pin and net density are computed using the structural and spatial features of the netlist and the interconnect graphs in EDA-schema.

### 2. Baseline Analysis

The quality of results metrics (PPA) evaluated on the initial physical design stage (floorplan, placement, and CTS) by the design tool are considered as the baselines used for evaluation of the developed models that predict design parameters after completion of the final design stage (routing). The models predict final stage design parameters based on data available in the currently executing physical design stage. The baseline and prediction errors are evaluated using Mean Absolute Error (MAE) and Mean Absolute Percentage Error (MAPE), which are calculated as, respectively, in Equations 2 and 3 (FIG. 35), for metric M with baseline Mb, where n is the total number of samples in the overall dataset.

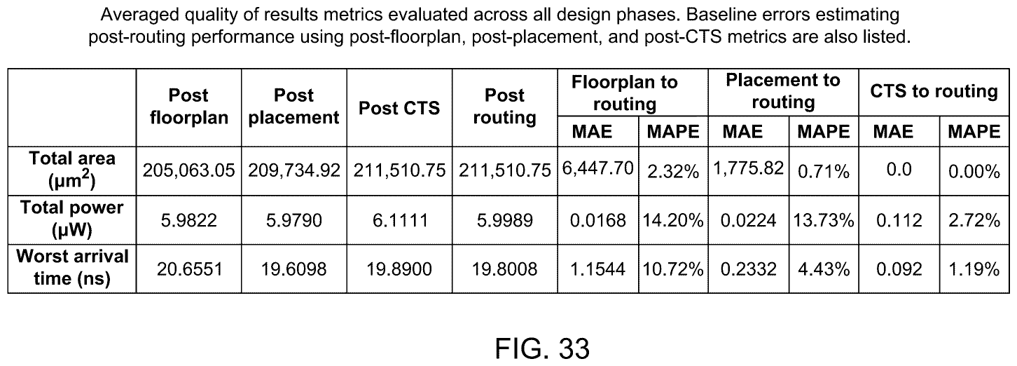

Downstream prediction of (a) total area, (b) total power, and (c) worst case arrival time is performed using EDA-schema, with results compared against baseline estimates provided by OpenROAD. Results are listed in Table 16 (FIG. 33) from the evaluation of the post-routing metrics when analyzed across all design phases and is compared to the corresponding baseline errors. Machine learning models that address prediction problems are expected to outperform the baseline estimates provided by EDA tools. The estimates provided by the EDA tools improve as the design flow progresses through each physical design stage. Completion of physical placement and routing provides more accurate data, which leads to improved estimates of the quality metrics of the design. In contrast, the total power consumption predicted by the EDA tool exhibits higher absolute error in later stages of the design flow due to modifications to the logic that optimize the power, performance, and area of the circuit.

In this disclosure, EDA-schema, a property graph data model that facilitates the use of machine learning in circuit design automation is described. An open-source dataset, generated from 20 benchmark circuits using the Skywater 130 nm PDK and the OpenROAD toolset offers a large initial set of physical designs for analysis. The dataset includes 960 circuits (20 unique designs) that include 20,272,194 gates, 11,086,480 interconnects, and 5,020,528 timing paths. The generated raw dataset, which includes 428 GB of netlists and performance metric reports, is curated into an 82.83 GB dataset using the EDA-schema and is made publicly available. The diversity and completeness of the dataset provides a valuable resource for researchers. An analysis of the adaptability and extensibility of EDA-schema is performed, demonstrating the potential use of the schema for various research tasks, which ultimately advances the field of machine learning for digital design automation.

Certain advantages of the system and method described herein include but are not limited to:
1. Broad Applicability: Supports diverse graph types and downstream metrics, enabling use across a wide range of EDA prediction tasks
2. Interoperability: Schema integrates with ML pipelines via standardized metadata and ontologies.
3. Reusability: Parameterized datasets can be regenerated or extended with new PDKs or benchmarks
4. Accuracy and Efficiency: Feature importance analysis and hybrid graph approaches improve prediction performance and reduce training complexity
5. Scalability: Supports multi-stage predictions and iterative updates, accommodating both early-stage estimates and late-stage refinements.

While the invention has been described with reference to the embodiments above, a person of ordinary skill in the art would understand that various changes or modifications may be made thereto without departing from the scope of the claims.

We claim:

1. A computer-implemented method for predicting one or more downstream performance metrics in an integrated circuit (IC) design flow, comprising:
converting design data from an initial design stage into at least one graph representation comprising nodes and edges;
associating each node and edge with a plurality of features including at least one structural feature, one spatial feature, and one performance metric feature;
applying a graph neural network selected from a graph convolutional neural network (GCN), a spatial graph convolutional neural network (SGCN), or a hybrid thereof to the graph representation to generate node-level and/or graph-level embeddings; and
predicting, using a machine learning model, the one or more downstream performance metrics for a subsequent design stage based on the embeddings.

2. The method of claim 1, wherein the prediction comprises a multi-stage prediction from the initial design stage to an intermediate design stage and to the subsequent design stage.

3. The method of claim 1, wherein the downstream performance metric is selected from: arrival time at a post-routing stage, interconnect parasitic impedance, total power consumption, total area, or slack violation count.

4. The method of claim 1, wherein the graph representation is selected from: a netlist graph, a timing path graph, an interconnect graph, a clock network graph, or a fused multi-graph representation.

5. The method of claim 1, further comprising performing feature importance analysis on the plurality of features using a technique selected from sensitivity analysis, SHAP values, or mutual information ranking, and removing ineffective features from the model.

6. The method of claim 1, wherein graph-level features include at least one of: area metrics, timing metrics, congestion metrics, pin density, cell density, or net density.

7. The method of claim 1, wherein node features include at least one of: gate type, drive strength, position coordinates, parasitic capacitance, parasitic resistance, or static timing analysis-derived values.

8. The method of claim 1, wherein the embeddings are used to train a neural regression model using a composite loss function including at least one of mean absolute percentage error (MAPE), mean absolute error (MAE), or a weighted combination thereof.

9. The method of claim 1, wherein the graph representation is generated from data files selected from Verilog, Design Exchange Format (DEF), Library Exchange Format (LEF), Liberty (.lib), or Standard Parasitic Extraction Format (SPEF) files.

10. The method of claim 1, wherein the machine learning model comprises a pooling layer for graph-level predictions and omits the pooling layer for node-level predictions.

11. The method of claim 1, wherein the graph representation is augmented with synthetic features generated by simulation, statistical modeling, or domain-specific transformations.

12. The method of claim 1, wherein the machine learning model comprises an ensemble of two or more graph neural networks trained on different subsets of features.

13. The method of claim 1, further comprising normalizing feature scales across graphs using technology-node-specific scaling factors.

14. The method of claim 1, wherein the prediction is updated iteratively at two or more intermediate stages of the design flow.

15. A computer-implemented method for generating a parameterized dataset of integrated circuit physical designs, comprising:
selecting a plurality of benchmark circuits;
synthesizing the benchmark circuits into gate-level netlists using a selected process design kit;
performing placement, clock network synthesis, and routing for each netlist under a plurality of parameter configurations;
extracting structural data, parasitic data, and quality-of-results (QoR) metrics for each generated design; and
formatting the dataset into a graph-based schema comprising graph entities and tabular entities as defined in claim 11.

16. The method of claim 15, wherein the parameter configurations vary at least one of: clock period, core aspect ratio, utilization, clock skew, or maximum fanout.

17. The method of claim 15, wherein the dataset is annotated with ontology-based metadata defining each feature and its relationships for use in machine learning pipelines.

18. The method of claim 15, wherein the dataset includes design instances from multiple technology nodes.

19. A graph-based data schema for representing digital IC designs across multiple physical design stages, the schema comprising:
a plurality of graph entities including netlist graphs, interconnect graphs, timing path graphs, and clock network graphs, wherein nodes and edges in each graph are associated with attributes selected from structural features, quality-of-results (QoR) metrics, and parasitic characteristics; and
a plurality of tabular entities storing features of circuit subcomponents linked to corresponding graph entities.

20. The schema of claim 11, wherein the structural features are derived from at least one of: DEF, LEF, Liberty, or SPEF files.
